(19) United States
(12) Patent Application Publication
(10) Pub. No.: US 2020/0156912 A1
(43) Pub. Date: May 21, 2020

(54) Sheet Material Transport And Lifting Device

(71) Applicant: Quantum Workhealth Programmes Pty Ltd, Essendon (AU)

(72) Inventor: Ricardo CARLEI, Essendon (AU)

(21) Appl. No.: 16/469,796

(22) PCT Filed: Dec. 14, 2017
(86) PCT No.: PCT/AU2017/051390

§ 371 Date: Jun. 14, 2019

(30) Foreign Application Priority Data
Dec. 14, 2016 (AU) 2016905169
May 29, 2017 (AU) 2017902025

(51) Int. Cl. B66F 9/18

(52) U.S. Cl. CPC B66F 9/181

(57) ABSTRACT

A device for lifting and transporting sheet material has a base portion, wheels on which the base portion is supported, a mast that extends upwardly from the base portion, a supporting head that is configured to support sheet material, a carriage to which the supporting head is mounted, and a lifting mechanism to support the carriage in the longitudinal direction of the mast. The lifting mechanism includes a winch, and a cable that is connected to the winch, passes over a first pulley located at or near the upper end of the mast and under a second pulley that is mounted on the carriage. An end of the cable is secured or securable at or adjacent an upper end of the mast. The winch and the first and second pulleys are all positioned on one side of the mast. The carriage is displaceable along the mast by operation of the winch.

### FIELD OF THE INVENTION

The present invention relates to a device for lifting and transporting sheet material.

### BACKGROUND

Sheet materials can be difficult to handle, particularly in respect of larger sheets and/or sheets made of materials with a high density, which can be particularly heavy. Sheet materials include glass panes, insulated glass units (“IGUs”), framed windows/IGUs, plasterboard, timber boards (including engineered timber materials), doors, fibre cement sheet, and the like. Current architectural trends favour large, uninterrupted glazing that has a low thermal conductivity. Consequently, large and heavy individual glass sheets, and IGUs are commonly used in new buildings and in renovations.

Manual handling of sheet materials is undesirable for health and safety reasons. To limit the manual lifting of sheet materials for transportation and installation, it is known to use devices, such as motorized and hand-operated trolleys/carts. In the glazing industry, these devices can reduce the number of people required to lift, transport and install glass panes, etc. Hand-operated devices have the advantage of being light weight, and can enable a single user at a job site to transport and install glass panes with a mass in excess of 100 kg, and/or have a long edge that is in excess of 3 metres. However, due to reliability and handling considerations, such devices need to be sufficiently rigid, and of an appropriate size. This can result in the device itself being heavy and large, which can be problematic in transporting the device to and from a job site.

There is a need to address the above, and/or at least provide a useful alternative.

### SUMMARY

There is provided a device for lifting and transporting sheet material, the device comprising:

a base portion;

wheels on which the base portion is supported, such that the base portion is movable across a surface on the wheels;

a mast that extends upwardly from the base portion;

a supporting head that is configured to support sheet material above the surface;

a carriage to which the supporting head is mounted, the carriage is in engagement with the mast so that carriage is displaceable along the mast and is guided by the mast; and

a lifting mechanism to support the carriage in the longitudinal direction of the mast, the lifting mechanism including a winch, and a cable that is connected to the winch, passes over a first pulley located at or near the upper end of the mast and under a second pulley that is mounted on the carriage, and an end of the cable is secured or securable at or adjacent an upper end of the mast, wherein the winch and the first and second pulleys are all positioned on one side of the mast, and wherein the carriage is displaceable along the mast by operation of the winch.

Preferably, the device further comprises a handle that extends from the base portion in a rearward direction of the device, and wherein the winch and the first and second pulleys are positioned between the mast and the handle.

In some embodiments, the lateral separation of the rotational centre of the second pulley from the mast is less than the lateral separation of the rotational centre of the first pulley from the mast.

The device can further comprise a mast head bracket at the upper end of the mast, wherein the first pulley is supported on the mast head bracket. The device can also comprise a cable guide for guiding a portion of the cable that is between the first pulley and the winch onto the first pulley.

Preferably, the cable guide includes a transverse portion that has an aperture through which the cable is to pass.

The mast head bracket can include a shaft member on which the first pulley is rotatably mounted, and wherein the cable guide is mounted on the shaft member, whereby the transverse portion of the cable guide is rotatable about the shaft member. Preferably, the cable guide includes at least one lateral portion from which the transverse portion extends, the or each lateral portion having an aperture through which the shaft member extends. More preferably, the cable guide has two lateral portions, and the first pulley is mounted on the shaft member between the two lateral portions.

In some embodiments, the first pulley includes a circumferential groove in which the cable runs. In such embodiments, the mast head bracket can include a guide pin located between the first pulley and the mast, wherein the guide pin inhibits the cable moving out of the circumferential groove of the first pulley. Preferably, the separation of the guide pin from the radial edge of the first pulley is less than the cable thickness. Alternatively or additionally, the separation of the guide pin from the radial edge of the first pulley is less than at least one of the width or depth of the circumferential groove of the first pulley.

Preferably, the device includes a winch mounting member to which the winch is mounted, or is mountable,

wherein, when the winch is mounted to the device, the winch is in a fixed position relative to the mast.

In some embodiments, the winch mounting member is part of the base portion.

The device can further comprise an extendible arm having an inner end that is connected to the carriage, and an outer end that is connected to the supporting head, the extendible arm being operable to displace the supporting head in a direction transverse to the mast from a retracted position in which the supporting head is proximal to the carriage, to an extended position in which the supporting head is spaced from the carriage, the extendible arm including a drive transfer mechanism that has an input connector for connecting to a drive element, the drive transfer mechanism is operable via the input connector to adjust the separation of the carriage and the supporting head.

In at least some embodiments, the extendible arm includes a parallelogram linkage comprising:

an inner linkage bracket that is connected to the carriage;

an outer linkage bracket that is connected to the supporting head;

a pair of inner supports that are each pivotally connected to the inner linkage bracket;

a pair of outer supports that are each pivotally connected to the outer linkage bracket;

two intermediate pivots that each connect one of the inner supports to one of the outer supports,

wherein when the extendible arm is in the retracted position, the intermediate pivots are spaced apart and the inner and outer brackets are adjacent one another,

wherein when the extendible arm is in the extended position, the intermediate pivots are adjacent one another and the inner and outer brackets are spaced apart.

Preferably, a first of the intermediate pivots has a through hole bushing, and a second of the intermediate pivots has an internally threaded through hole, and the drive transfer mechanism comprises a leadscrew that has a first end portion that is rotationally constrained in the through hole bushing of the first intermediate pivot, and an external threaded portion that is in threaded engagement with the internally threaded through hole of the second intermediate pivot,

wherein the input connector is in the form of a drive head on an end of the leadscrew, the drive head being shaped to be engaged by a tool, such that rotation of the drive head causes the leadscrew to rotate and thereby cause displacement of the intermediate pivots relative to one another.

In some embodiments, the drive head is secured to the first end portion of the leadscrew.

In some embodiments, the outer linkage bracket has two outer pivots, and each outer support is pivotally connected to a respective one of the outer pivots. The inner linkage bracket can also have two inner pivots, and each inner support is pivotally connected to a respective one of the inner pivots.

The extendible arm can be arranged such that the axes defined by the inner pivots, the outer pivots, and the intermediate pivots are transverse to a horizontal plane. In some alternative embodiments, extendible arm can be arranged such that the axes defined by the inner pivots, the outer pivots, and the intermediate pivots are approximately parallel to a horizontal plane.

Preferably, each of the outer supports includes one or more outer mesh plates, each outer mesh plate includes a through hole through which the respective outer pivot extends, and a circle segment portion that includes set of gear teeth, wherein the gear teeth of each outer mesh plate are in engagement with the gear teeth of a corresponding outer mesh plate on the other outer support. In certain embodiments, each of the outer supports is provided with two outer mesh plates.

Alternatively or additionally, each of the inner supports includes one or more inner mesh plates, each inner mesh plate includes a through hole through which the respective inner pivot extends, and a circle segment portion that includes set of gear teeth, wherein the gear teeth of each inner mesh plate are in engagement with the gear teeth of a corresponding inner mesh plate on the other inner support. In certain embodiments, each of the inner supports is provided with two inner mesh plates.

In at least some embodiments, the extendible arm is inclined such that the outer linkage bracket is raised relative to the inner linkage bracket.

There is also provided a device for lifting and transporting sheet material, the device comprising:

a base portion;

wheels on which the base portion is supported, such that the base portion is movable across a surface on the wheels;

a mast that extends upwardly from the base portion;

a supporting head that is configured to support sheet material above the surface;

a carriage to which the supporting head is mounted, the carriage being in engagement with the mast so that carriage is displaceable along the mast and being guided by the mast; and

a lifting mechanism to support the carriage in the longitudinal direction of the mast, the lifting mechanism having:
a winch unit that includes a winch and a mounting bracket on which the winch is mounted, the mounting bracket being releasably connectable by a coupling to one of the base portion, or a component of the device that is fixed relative to the mast,
a cable that is connected to the winch, and
one or more pulleys, at least one of which is located at or near the upper end of the mast,

wherein an end of the cable is secured or securable at one of the carriage, or a position on or adjacent an upper end of the mast, such that the carriage is displaceable along the mast by operation of the winch.

Preferably, the coupling of the lifting mechanism includes one or more connecting members that secure the winch unit to the base. Additionally or alternatively, the coupling of the lifting mechanism includes one or more complementary inter-engaging formations that, when inter-engaged, inhibit separation of the base portion and the winch unit. The complementary inter-engaging formations can be an integral parts of the base portion and/or the mounting bracket, or may include a separate component that co-operates with formations on the base portion and the mounting bracket in an inter-engaging arrangement.

In some embodiments, the base portion and mounting bracket are configured to overlap when the winch unit is connected to the base portion, and each of the base portion and mounting bracket have holes that are positioned so as to align when the winch unit is connected to the base portion, and the connecting members include a pin-type connecting member with a shank that passes through aligned holes in the base portion and mounting bracket to secure the winch unit to the base portion. Preferably, the pin-type connecting member is configured to inhibit inadvertent removal of the pin-type connecting member from the aligned holes. More preferably, the pin-type connecting member has a quick release mechanism to inhibit inadvertent removal of the pin-type connecting member from the aligned holes.

In some embodiments, the connecting members include a key member that projects, or is configured to project, from the base portion, and wherein the mounting bracket has a slot, and wherein the key member and slot are shaped such that, when the winch unit is connected to the base portion, the key member inter-engages with the mounting bracket around the slot to inhibit separation of the base portion and the winch unit.

Preferably, the key member has a foot portion that can pass through the slot in the mounting bracket. In some embodiments, the base portion may include a slot that is positioned to overlap with the slot in the mounting bracket when the winch unit is connected to the base portion, and a head portion of the key member is shaped to inter-engage with the base portion around the base portion slot.

In some embodiments, the base portion includes a winch mounting member to which the mounting bracket of the winch unit is releasably connectable.

There is also provided a device for lifting and transporting sheet material, the device comprising:

a base portion;

wheels on which the base portion is supported, such that the base portion is movable across a surface on the wheels;

a mast that extends upwardly from the base portion, the mast including a lower section that is connected to the base portion, at least one intermediate section that is configured to be removably interconnectable with the lower section, and an upper section that is removably interconnectable with both the lower section and the intermediate section;

a supporting head that is configured to support sheet material above the surface;

a carriage to which the supporting head is mounted, the carriage being in engagement with the mast so that carriage is displaceable along the mast and being guided by the mast; and

a lifting mechanism to support the carriage in the longitudinal direction of the mast, the lifting mechanism having:
a winch unit that includes a winch and a mounting bracket on which the winch is mounted, the mounting bracket being releasably connectable by a coupling to one of the base portion, or a component of the device that is fixed relative to the mast,
a cable that is connected to the winch, and
one or more pulleys, at least one of which is located at or near the upper end of the upper section of the mast,

wherein an end of the cable is secured or securable at one of the carriage, or a position on or adjacent an upper end of the upper section, such that the carriage is displaceable along the mast by operation of the winch.

Preferably, the intermediate section is interconnectable with the lower section by a male-female type connection, and the upper section is removably interconnectable with both the lower section and the intermediate section by a male-female type connection.

The device can further comprise a carriage lock to releasably retain the carriage at a desired vertical position along the mast.

In some embodiments, the upper end of the lower section is hollow to provide the female part of the male-female type connection, and the intermediate section and upper section each have a connector portion that provides the male part of the male-female type connection. In such embodiments, the upper end of the intermediate section is hollow to provide the female part of the male-female type connection.

Preferably, at least an upper portion of the lower section has an outer peripheral surface that guides the carriage during movement along the lower section. The intermediate section, and the upper section can each have a body portion with an outer peripheral surface that guides the carriage during movement along the mast. In the assembled device, the outer peripheral surfaces in adjacent interconnected sections of the mast are in alignment to guide the carriage across a transition between the outer peripheral surfaces of the adjacent sections of the mast. Alternatively or additionally, in the assembled device, the outer peripheral surfaces in adjacent interconnected sections of the mast are in abutment.

In some embodiments, the intermediate section and upper section each have a connector portion that provides the male part of the male-female type connection. Preferably, in each of the intermediate section and upper section the connector portion is secured within the body portion.

In certain embodiments, the connector portion is in the form of a pair of flanges that are interconnected by a web formation. Each of the flanges can have a pair of bevelled edges. The web formation can be a tube.

### BRIEF DESCRIPTION OF THE DRAWINGS

In order that the invention may be more easily understood, an embodiment will now be described, by way of example only, with reference to the accompanying drawings, in which:

FIG. 1: is a left side, perspective view of a sheet material transport and lifting device, the device being in accordance with a first embodiment of the present invention;

FIG. 2: is a left side view of the sheet material transport and lifting device of FIG. 1;

FIG. 3: is an enlarged view of Region III in FIG. 2;

FIG. 4: is an enlarged view of Region IV in FIG. 1, showing the mast head bracket of the sheet material transport and lifting device;

FIG. 5: is a top view of the mast head bracket shown in FIG. 4;

FIG. 6: is an enlarged view of Region VI in FIG. 1;

FIG. 7: is a front perspective of the winch unit of the sheet material transport and lifting device of FIG. 1;

FIG. 8: is a front view of the winch unit shown in FIG. 7;

FIG. 9: is a top view of the winch unit shown in FIG. 7;

FIG. 10: is a rear perspective view of the sheet material transport and lifting device of FIG. 1 in a partially disassembled state;

FIG. 11: is an enlarged view of Region XI in FIG. 10;

FIG. 12: is a vertical section view through the winch unit and winch mount of the sheet material transport and lifting device of FIG. 1;

FIG. 13: is a rear perspective view of the carriage and supporting head of the sheet material transport and lifting device of FIG. 1;

FIG. 14: is a top view of the carriage and supporting head shown in FIG. 13;

FIG. 15: is an enlarged view of Region XV in FIG. 12;

FIG. 16: is a left side perspective view of the sheet material transport and lifting device of FIG. 1, showing the supporting head in the second position;

FIG. 17: is a left side, perspective view of a sheet material transport and lifting device, the device being in accordance with a second embodiment of the present invention;

FIG. 18: is a left side view of the sheet material transport and lifting device of FIG. 17;

FIG. 19: is a top view of the sheet material transport and lifting device of FIG. 17;

FIG. 20: is a right side view of the sheet material transport and lifting device of FIG. 17, showing the extendible arm in a fully retracted position;

FIG. 21: is a right side view of the sheet material transport and lifting device of FIG. 17, showing the extendible arm in an intermediate position;

FIG. 22: is a right side view of the sheet material transport and lifting device of FIG. 17, showing the extendible arm in a fully extended position;

FIG. 23: is an enlarged view of Region XXIV in FIG. 21;

FIG. 24: is an enlarged view of Region XXIIII in FIG. 20;

FIG. 25: is an enlarged view of Region XXV in FIG. 22;

FIG. 26: is a right side view of the sheet material transport and lifting device of FIG. 17, showing the supporting head in a fully retracted and fully lowered position; and

FIG. 27: is a right side view of the sheet material transport and lifting device of FIG. 17, showing the supporting head in a fully extended and fully raised position;

FIG. 28: is a schematic left side view of a sheet material transport and lifting device according to a third embodiment of the present invention;

FIG. 29: is a left side view of the device of FIG. 28, with the intermediate mast section installed;

FIG. 30: is a left side view of the device of FIG. 28, with the intermediate mast section removed;

FIG. 31: is an exploded view of Region XXXI in FIG. 29; and

FIG. 32: is a lower perspective view of the intermediate mast section of the device of FIG. 28.

### DETAILED DESCRIPTION

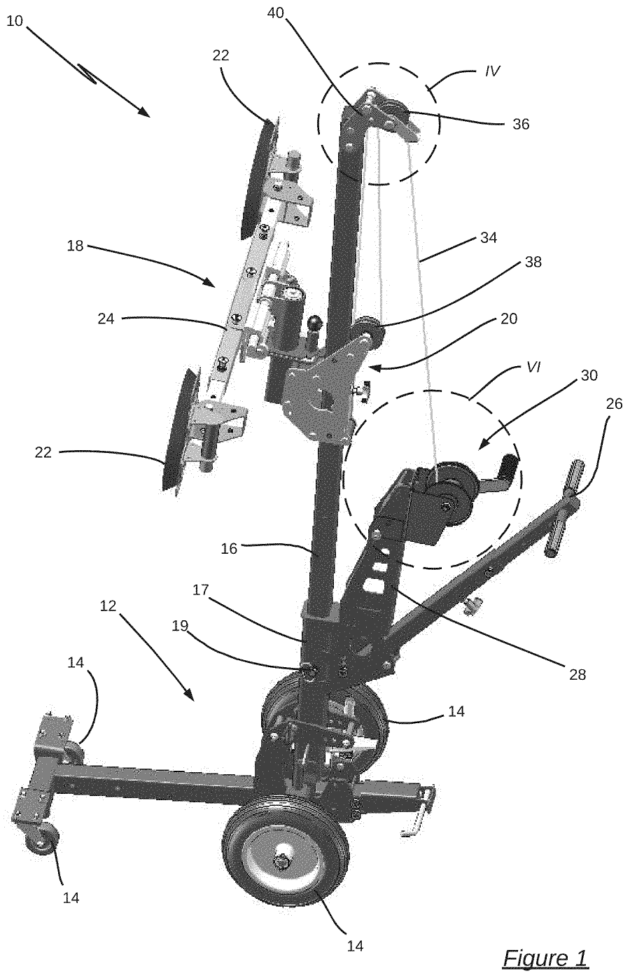

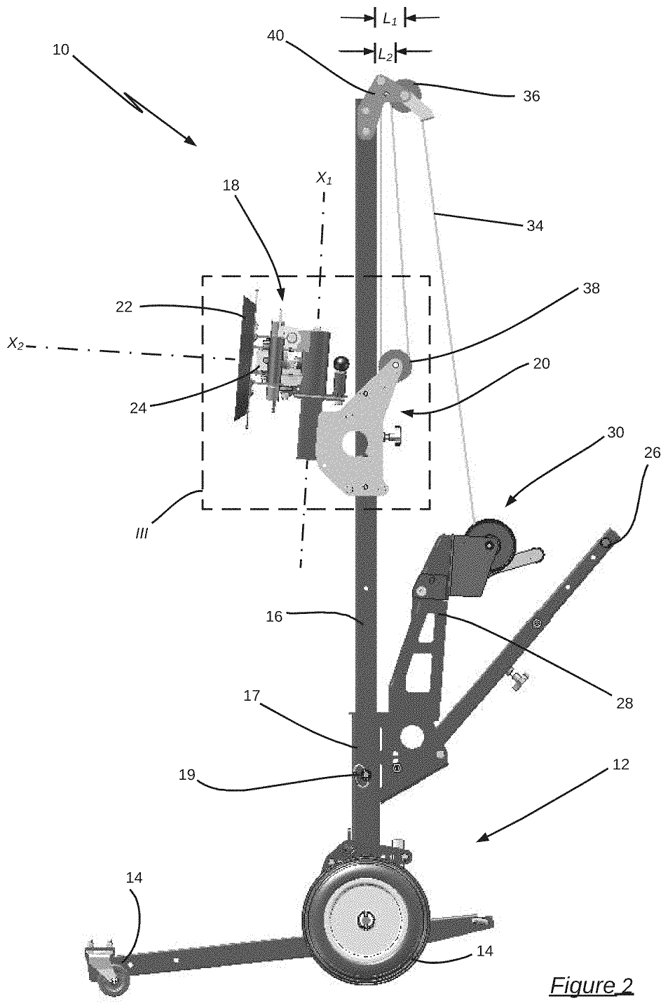

FIGS. 1 and 2 show a device 10 according to a first embodiment of the present invention. The device 10 is intended for use in lifting and transporting sheet material.

The device 10 includes a base portion 12, and rear wheels 14a and front wheels 14b on which the base 12 is supported. The wheels 14a, 14b enable the base portion 12, and thus the device 10, to be moved across a surface. The device 10 includes a mast 16 that extends upwardly from the base portion 12. The base portion 12 includes a sleeve 17, into which the lower end of the mast 16 is located and secured.

A supporting head 18 that is configured to support sheet material is mounted on a carriage 20. The carriage 20 is in engagement with the mast 16 in a manner that enables the carriage 20 to be displaceable along the mast 16, and also be guided by the mast 16. In this particular embodiment, the supporting head 18 has two vacuum grips 22 at opposing ends of a cross beam 24.

The base portion 12 includes a handle 26 that is positioned at the rear of the device 10, relative to the wheels 14a, 14b. A user can grasp the handle 26 to manipulate and move the device 10. The direction from the handle 26 through the mast 16 defines a forward direction for the device 10.

The device 10 also has a lifting mechanism to vertically support the carriage 20 along the mast 16. In this particular embodiment, the lifting mechanism including a winch unit 30 with a winch 32, and a cable 34 that is connected to the winch 32. The cable 34 passes over a first pulley 36 located at or near the upper end of the mast 16 and under a second pulley 38 that is mounted on the carriage 20, and is secured adjacent an upper end of the mast 16. In this embodiment, the winch 32 is of the type that has a handle rotatably connected to a drum. Rotation of the handle causes cable to be wound onto, or fed off the drum, depending on the direction of handle rotation.

As will be appreciated, the lifting mechanism arrangement provides a 2:1 reduction of cable movement to carriage displacement along the mast 16.

As is evident from FIG. 2, in this embodiment, the elongate direction of the mast 16 is centred over the rear wheels 14a.

In the illustrated embodiment, the base portion 12 also includes an arm 28 that extends rearwardly with respect to the device 10, and the winch unit 30 is connected to the upper end of the arm 28. Further, in this particular embodiment, the winch unit 30 is releasably connected to the arm 28, as discussed in further detail below. In some alternative embodiments, the winch unit may be connected, or connectable to another component of the device that is fixed in position relative to the mast. For instance, the mast may be part of a unit that includes the mast, and a side arm to which the winch unit is connected, or is connectable.

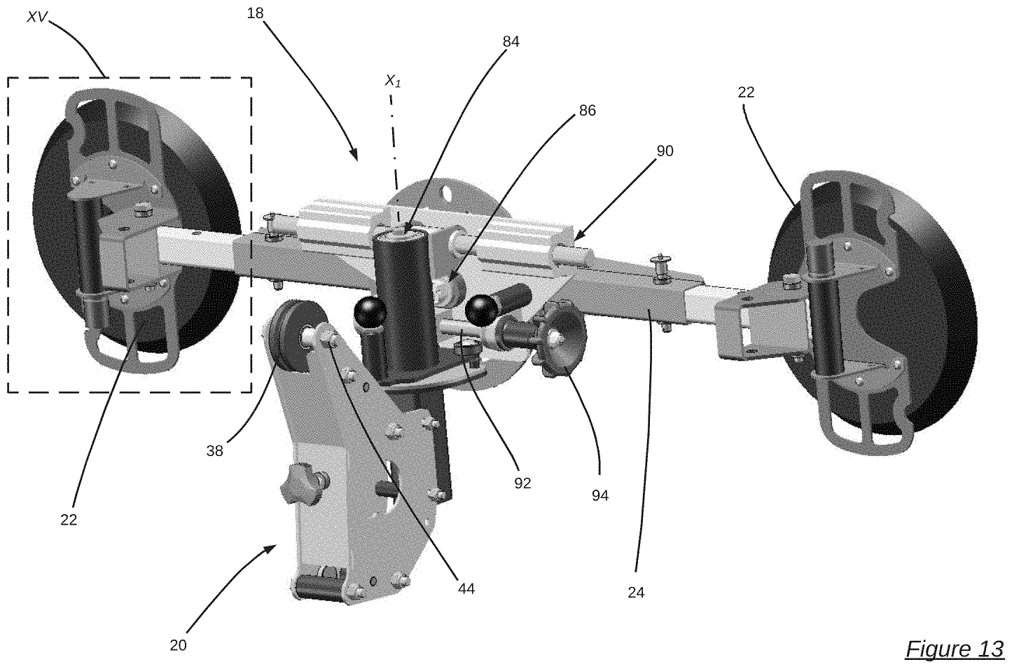

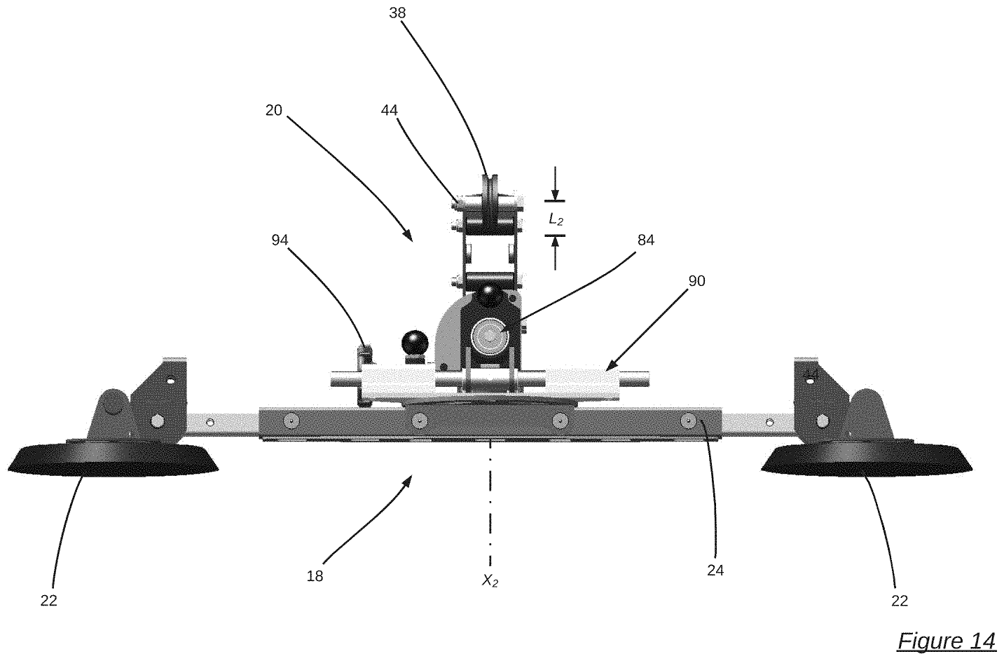

As shown in FIGS. 1 and 2, in the assembled device 10, the winch 32 is positioned between the mast 16 and the handle 28. Further, the first and second pulleys 36, 38 are mounted on the same side of the mast 16 as the winch 32. This configuration provides several advantages, including that the lateral separation of the supporting head 18 from the mast 16 is minimized, having regard to the operational characteristics of the supporting head 18 (discussed below in reference to FIGS. 13 and 14). This is particularly significant when the device 10 is heavily loaded, as down forces must be applied to the handle 26 in order to tilt the device 10 rearwardly on the rear wheels 14a —a movement that may be required to lift the front wheels 14b of the device 10, for instance to pass over a small step in a surface—and this configuration minimizes the necessary down force. Similarly, with regard to the lateral forces that must be applied to the handle 26 in order to cause the device 10 to yaw. In addition the component of the tensile forces in the cable 34 that are perpendicular to the elongate direction of the mast 16 are minimized. These advantages contribute to improving the stability and usability of the device 10, for instance when lifting and transporting heavy sheet material.

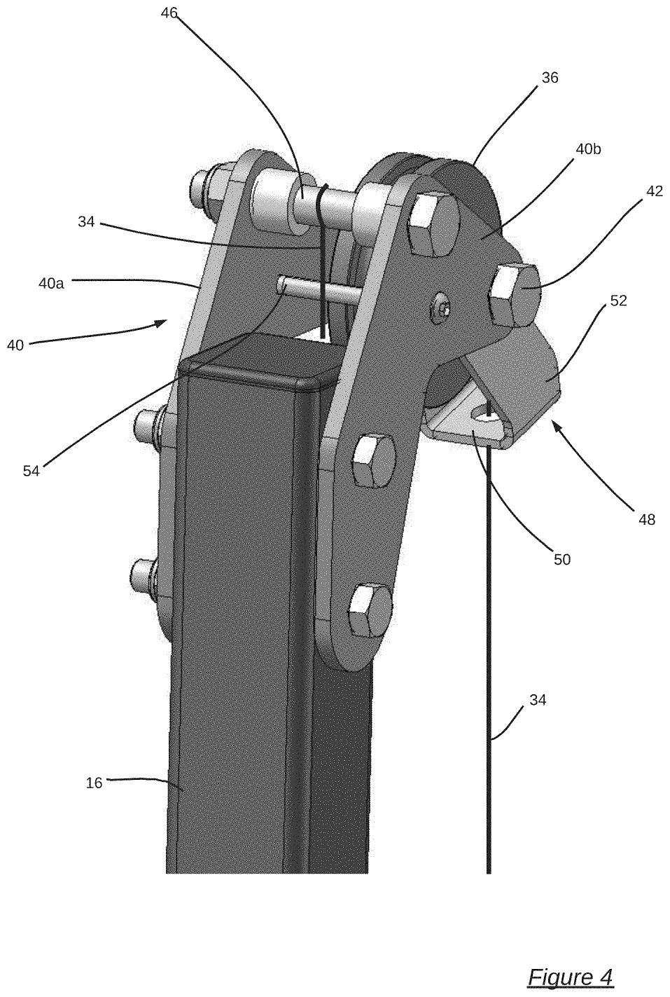

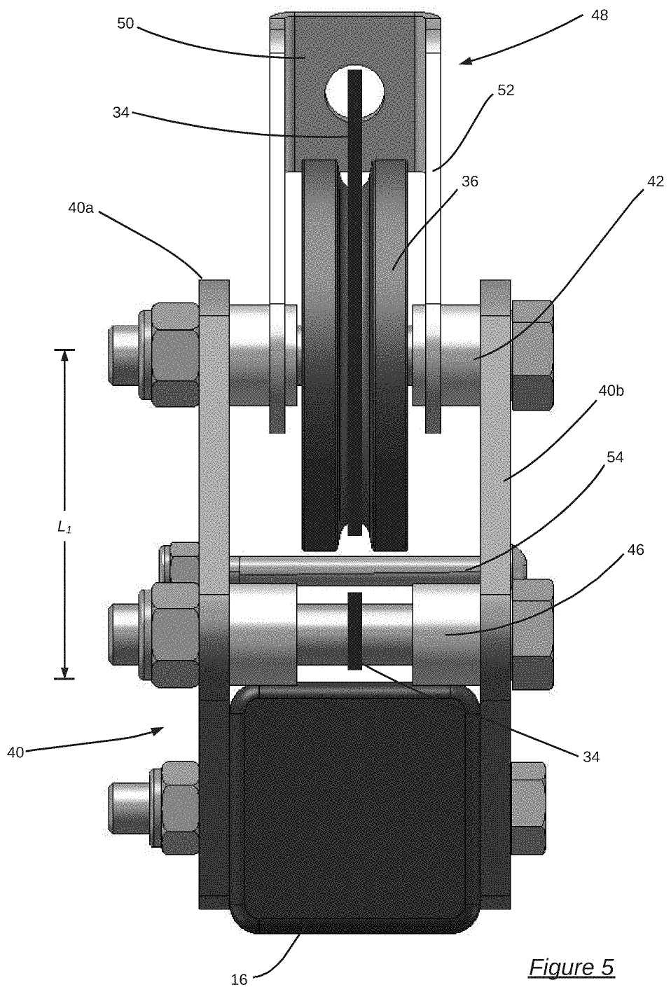

As shown in detail in FIGS. 4 and 5, a mast head bracket 40 is mounted to the upper end of the mast 16. The mast head bracket 40 includes a first pulley shaft 42, on which the first pulley 36 is rotatably mounted. The carriage 20 includes a second pulley shaft 44, on which the second pulley 38 is rotatably mounted. The lateral separation L₂ (indicated in FIGS. 2, 3 and 14) of the rotational centre of the second pulley 38 from the mast 16 is less than the lateral separation L₁ (indicated in FIGS. 2 and 5) of the rotational centre of the first pulley 36 from the mast 16. The mast head bracket 40 includes a cable termination shaft 46 to which the free end of the cable 34 is mounted. In this particular embodiment, the first and second pulley shafts 42, 44 and the cable termination shaft 46 are in the form of the shank of a bolt.

Sheet material—such as a glass pane, IGU, or the like—can be gripped by the vacuum grips 22, and lifted by winding cable 34 onto the drum of the winch 32, which raises the carriage 20 up the mast 16. Thus, the sheet material can be fully supported and transported by the device 10.

The device 10 includes a cable guide 48 positioned between the first pulley 36 and the winch 32, so that the cable guide 48 guides cable 34 onto and off the first pulley 36. In this embodiment, the cable guide includes a transverse plate 50 that has an aperture 52 through which the cable 34 is to pass. Further, the cable guide 48 has two lateral portions 52 from which the transverse plate 50 extends. Each of the lateral portions 52 has an aperture (not shown) through which the first pulley shaft 42 extends. In this way, the cable guide 48 is rotatably mounted on the first pulley shaft 42, such that the transverse plate 50 can rotate about the first pulley shaft 42.

As shown most clearly in FIG. 5, the mast head bracket 40 includes two spaced apart plates 40a, 40b that are secured to opposing sides of the mast 16. The first pulley 36 is mounted between the plates 40a, 40b on the first pulley shaft 42. In addition, the first pulley 36 is mounted between the two lateral portions 52 of the cable guide 48.

In this particular embodiment, the first and second pulleys 36, 38 each include circumferential grooves in which the cable 34 runs. As shown in FIGS. 4 and 5, the mast head bracket 40 includes a guide pin 54 that is located between the first pulley 36 and the mast 16. The guide pin 54 inhibits the cable 34 moving out of the circumferential groove of the first pulley 36. The separation of the guide pin 54 from the radial edge of the first pulley 36 is less than the cable thickness. This minimizes the likelihood of the cable 34 unintentionally coming out of the circumferential groove.

As previously mentioned, the winch unit 30 is releasably connected to the arm 28 of the base portion 12. The winch unit 30 (which is shown in detail in FIGS. 7 to 9) includes a mounting bracket 56 on which the winch 32 is mounted, and the mounting bracket 56 is releasably connectable by a coupling of the lifting mechanism to secure the winch unit 30 to the arm 28 of the base portion 12. The winch unit 30 has a winch shaft 58 that extends through holes (not shown) in the mounting bracket 56. The drum of the winch 32 is rotatable on the winch shaft 58. It will be appreciated that the winch 32 may include a gear set to which the winch handle 78 and drum are connected. However, in the Figures, the winch 32 is shown schematically, with the gear set omitted.

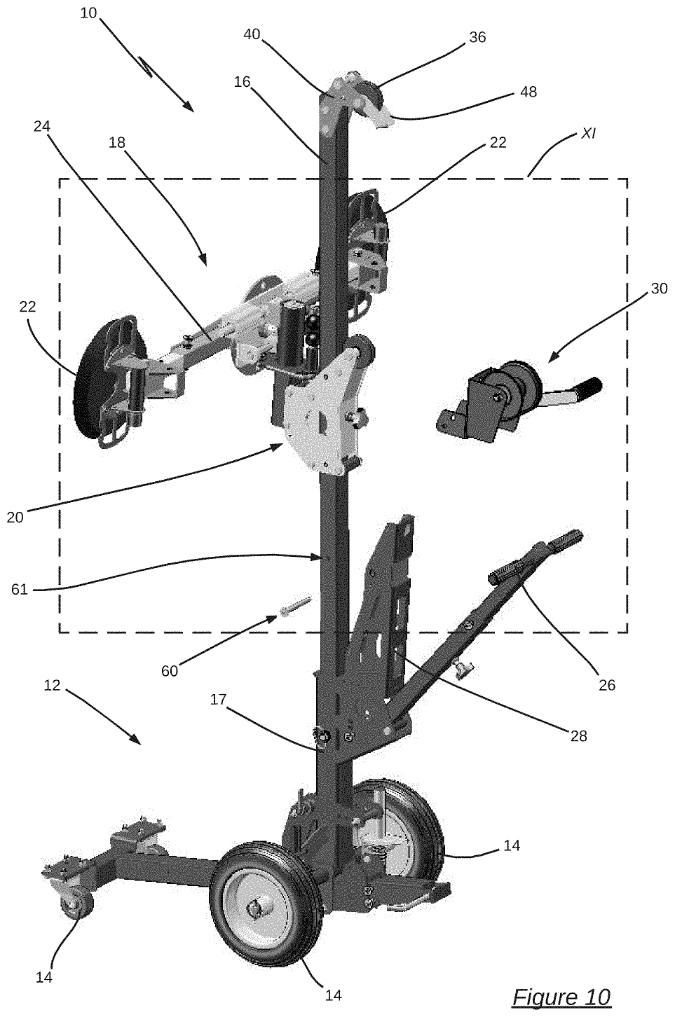

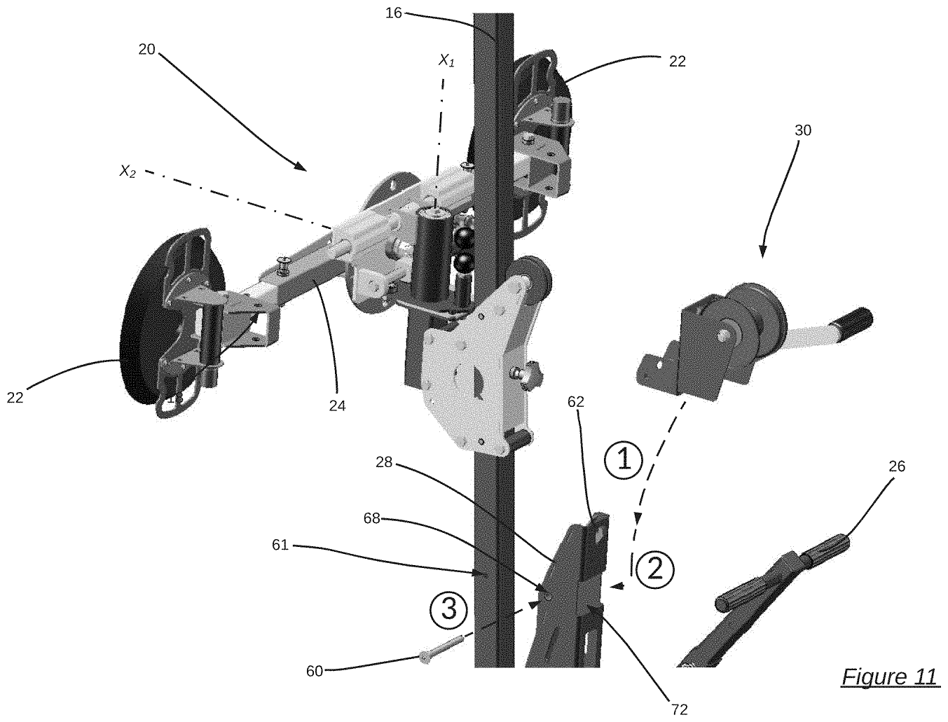

FIGS. 10 and 11 show detail of the coupling of the device 10 according to this particular embodiment. As shown in these Figures, the coupling is provided by a pin 60, and a key member 62 that is provided on the arm 28. Further, the arm 28 and mounting bracket 56 have shape features that facilitate a solid, reliable connection between the arm 28 and the winch unit 30.

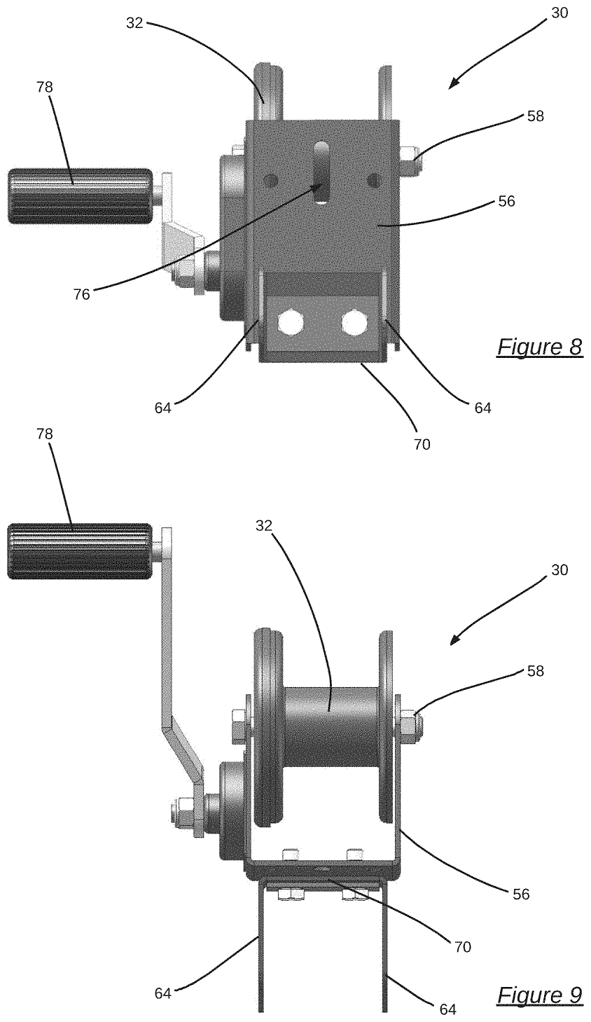

As shown particularly in FIGS. 7 and 9, the mounting bracket 56 has a pair of wings 64 that are sized to overlap with side panels of the arm 28, when the winch unit 30 is connected to the base portion 12. The wings 64 and side panels of the arm 28 are all planar, and lie in parallel planes. Further, an inward-facing surface of each wing 64 is adjacent to, or in contact with an outward-facing surface of a respective side panel. Each wing 64 has a hole 66 that is positioned to align with corresponding holes 68 in the side panels of the arm 28. When the holes 66, 68 are aligned, the shank of the pin 60 can be passed therethrough. In this particular embodiment, the pin 60 is a quick release pin of the ball lock type, which has a head at one end, and locking balls at the opposite end. A button in the head of the pin 60 is movable to release the locking balls, thus allowing the pin shank to be passed through/withdrawn from the holes 66, 68.

In addition, the mounting bracket 56 has a face plate 70 between the wings 64 that locates within a complementary shaped opening 72 in the arm 28. In particular, the height of the face plate 70 and opening 72 (in their respective directions that are generally orthogonal to the planes of the wings 64 and side panels) are approximately equal.

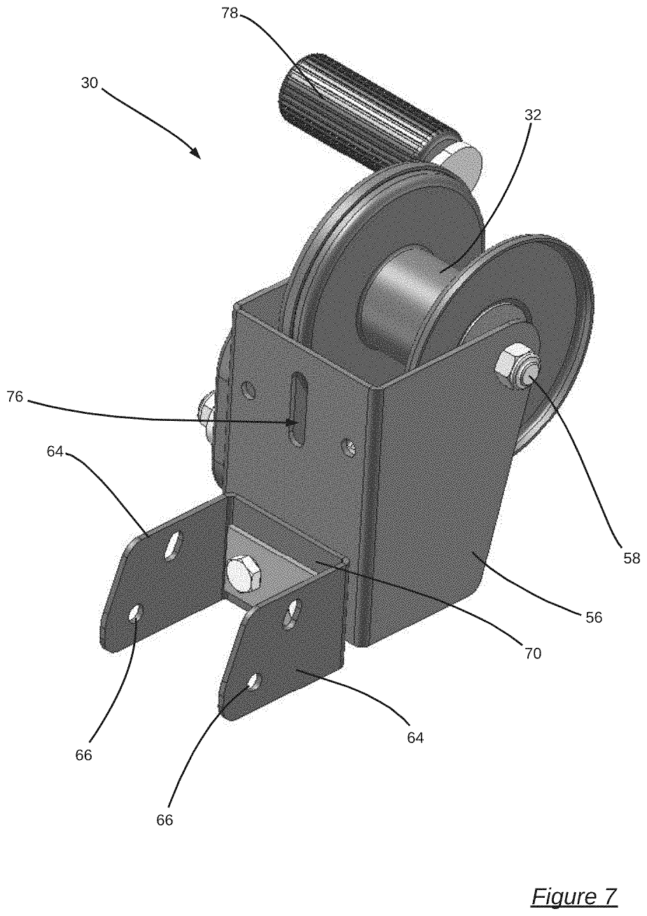

The coupling of the lifting mechanism is also provided by complementary inter-engaging formations that, when inter-engaged, inhibit separation of the base portion and the winch unit. In the illustrated embodiment, the connecting members of the lifting mechanism includes a key member 62 that projects rearwardly from the arm 28, as shown most clearly in FIG. 9. The mounting bracket 56 has a slot 76 (shown in FIGS. 7 and 8), the key member 62 and slot 76 are shaped such that, when the winch unit 30 is connected to the arm 28, the key member 62, when projecting from the arm 28, inter-engages with the mounting bracket 56 around the slot 76 to inhibit separation of the arm 28 and the winch unit 30.

In this particular embodiment, the key member 62 has a foot portion 80 that is shaped so as to pass through the slot 76 in the mounting bracket 56. Further, the key member 62 is integral with the arm 28. To this end, a head portion 82 of the key member 62 is secured to an internal surface of the arm 28.

The foot portion 80 forms a “hook” of the key member that is shaped to engage the mounting bracket 56 on one side of the slot 76. The slot 76 is of sufficient length for the foot portion 80 to pass through. Further, the “heel” of the foot portion 80 is shaped to allow the winch unit 30 to be manipulated relative to the arm 28 during connection and disconnection of the winch unit 30 and arm 28.

FIG. 8 indicates the procedure for connecting the winch unit 30 to the base portion 12, with major steps shown using encircled numbers 1 to 3. More particularly, this procedure involves:
Step 1: bringing the winch unit 30 to the arm 28, such that the foot portion 80 of the key member 62 passes through the slot 76;
Step 2: rotating the winch unit 30 relative to the arm 28, to inter-engage the foot portion 80 with the mounting bracket 56 around the slot 76 and locating the face plate 70 is within the opening 72; and
Step 3: inserting the pin 60 through the aligned holes 66, 68 in the wings 64 and side panels of the arm 28.

As may be appreciated, disconnecting the winch unit 30 from the base portion 12 can involve a reversal of the above described procedure. It will also be understood that the above described procedure may be varied, and/or that different embodiments may require different connecting/disconnecting procedures.

With respect to the illustrated embodiment, Step 3 may more particularly involve passing the foot portion 80 first through the slot 78 in the arm 28, and then through the slot 76 in the mounting bracket 56. The key member 62 is then to be rotated to locate the foot portion 80 against the mounting bracket 56 beside the slot 76, and also to locate the head portion 82 against the arm 28 beside the slot 78. In this position, the key member 62 is held in place by the forces that act on the winch unit 30 and the arm 28. To facilitate the insertion of the key member 62 through the aligned slots 76, 78, the arm 28 is shaped to provide the necessary access to the slot 78.

As shown in FIGS. 10 and 11, the mast 16 has transverse holes 61 (only one of which is visible in FIGS. 10 and 11). When the winch unit 30 is detached from the arm 28 (as described above), the winch unit 30 can be connected to the mast 16 by positioning the winch unit 30 against the mast 16, with the holes 66 in the wings 64 aligned with the transverse holes 61, and passing the pin 60 through the aligned holes 61, 66. In this way, the winch unit 30 is conveniently stowed against the mast 16, facilitating disassembly of the mast 16 from the sleeve 17 in the base 12.

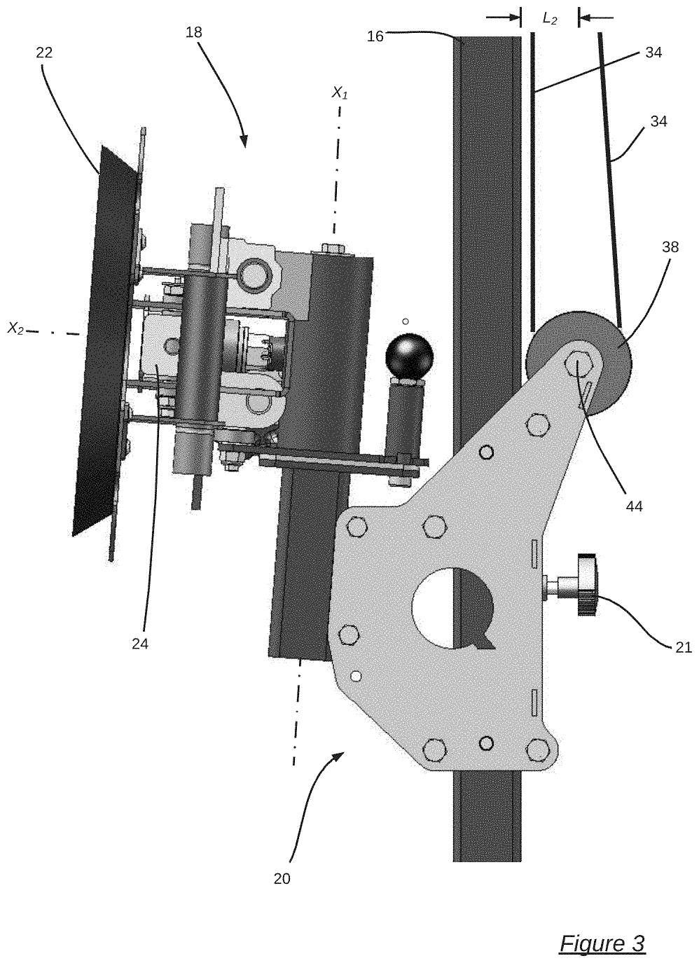

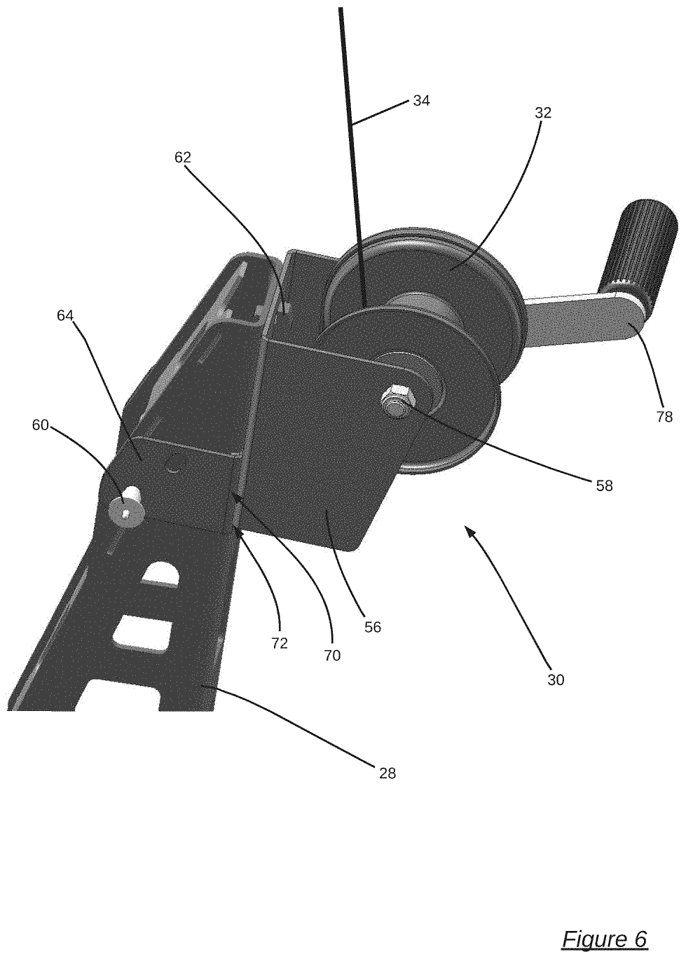

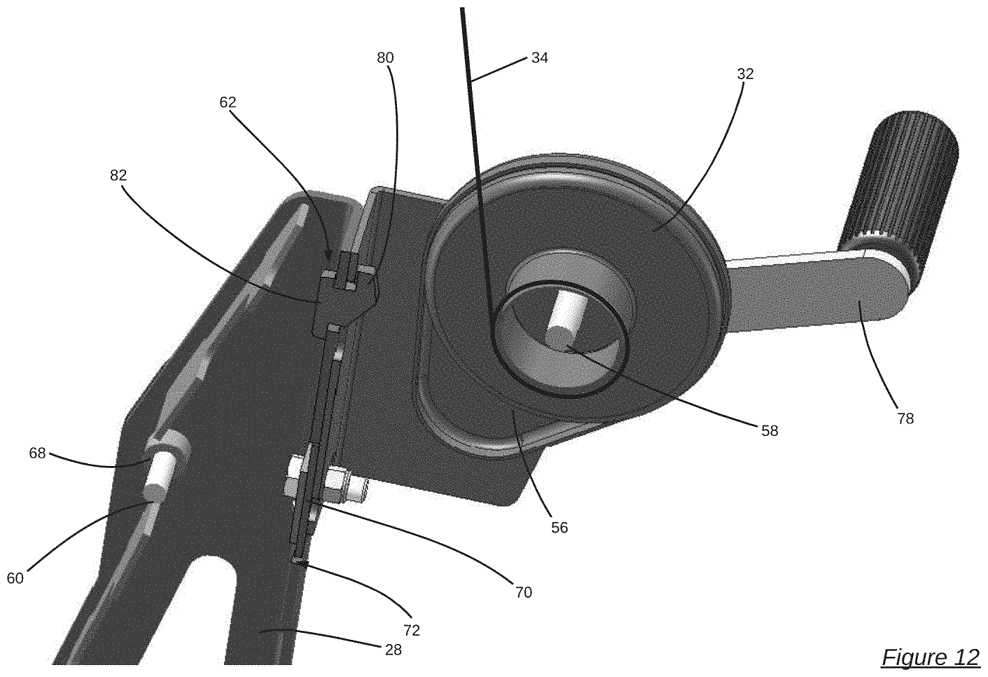

In this embodiment, the supporting head 18 includes two couplings, as shown in FIGS. 13 and 14. A pivot coupling 84 that enables the cross beam 24 to be rotated about a first axis X₁ between a first position in which sheet material supported by the supporting head 18 is in a generally transverse orientation forward direction of the device 10, and a second position in which the sheet material supported by the supporting head 18 is in a generally parallel orientation forward direction of the device 10. In FIGS. 1 to 15, the supporting head 18 is shown with the cross beam 24 in the first position. In FIG. 16, the supporting head 18 is shown with the cross beam 24 in the second position. As shown in FIGS. 2 and 3, the first axis X₁ is inclined to the vertical. In this way, when the supporting head 24 is in its first position, planar sheet material that is held on the vacuum grips 22 is inclined so that the uppermost edge/point of the sheet material is closer to the mast 16 than the lowermost edge/point.

The second coupling is a rotary coupling 86 that enables the cross beam 24 to be rotated about a second axis X₂, which is generally orthogonal to the first axis X₁. The rotary coupling 86 allows sheet material supported by the supporting head 18 to be rotated about the second axis X₂. The second axis X₂ is inclined to the horizontal

The supporting head 18 also includes side shift mechanism 88 that is arranged to move the cross beam 24 in a direction that is transverse to the longitudinal direction of the mast 16. The side shift mechanism 88 includes a sliding coupling 90 and a threaded bar 92. The sliding coupling 90 includes a rod that carries a support bracket to which the cross beam 24 is mounted The threaded bar 92 is rotatable to displace the cross beam 24, and thus also the vacuum grips 22 (and any sheet material that is carried by the supporting head 18). A turn knob 94 is attached to the threaded bar 92 for an operator to rotate when displacement of the cross beam 24 is desired.

The pivot and rotary couplings 84, 86, and side shift mechanism 88 have features similar to those of the devices described and illustrated in International (Patent) Publication No. WO 2015/161349, filed in the name of Quantum Workhealth Programmes Pty Ltd, the entire disclosure of which is incorporated herein by reference.

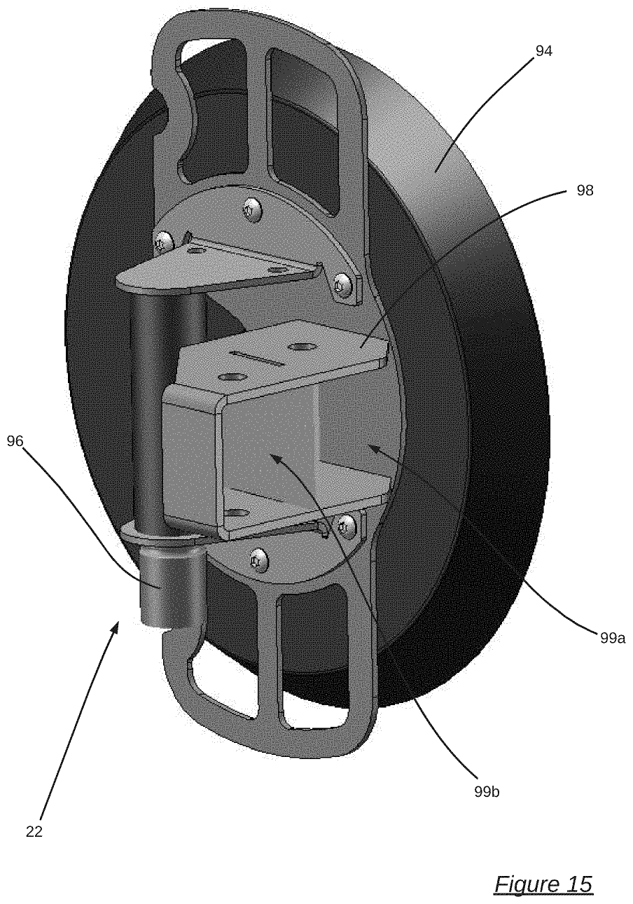

FIG. 15 shows one of the vacuum grips 22 of the supporting head 18. Each vacuum grip 22 includes a vacuum cup 94, and a piston 96 that is operable to draw air from the contact face of the vacuum cup 94. In this way, when the contact face is against sheet material, such as glass, an operator can work the piston 96 to extract air from the region between the vacuum cup 94 and the sheet material to create at least a partial vacuum. Each vacuum grip 22 also has a vacuum grip bracket 98 on which the vacuum cup 94 and piston 96 are mounted. As will be evident at least from FIG. 15, each vacuum grip bracket 98 has two throughways 99a, 99b. The cross beam 24 extends through a selected throughway 99a, 99b, and the vacuum grip bracket 98 is secured on the cross beam 24, as will be evident at least from FIGS. 13 and 14.

In each vacuum grip 22, the throughways 99a, 99b are spaced from one another in a direction that is generally perpendicular to the contact face of the vacuum cup 94. In this regard, it will be appreciated that the contact face need not be planar. Thus, the vacuum cups 94 can be mounted in two positions of differing lateral spacing from the cross beam 24. In the inward position (in which the cross beam 24 is positioned in throughway 99a, as shown in FIGS. 13 and 14), sheet material supported by the vacuum grips 22 is positioned close to the cross beam 24. This has the benefit of reducing forces required by the operator of the device 10, which is useful when handling heavy sheet material. In the outward position (in which the cross beam 24 is positioned in throughway 99b), sheet material supported by the vacuum grips 22 is positioned further from the cross beam 24 (with respect to the inward position). This has the benefit of enabling sheet material to be lifted/handled further away from the mast 16, for example on a dolly/truck ledge. Additionally, this has the benefit of enabling glazing in difficult to reach locations, such as into pocket frames of doors and windows.

As shown in FIG. 2, the base 12 includes a locking pin 19, which in the assembled device 10, passes through aligned holes in the sleeve 17, and in the base of the mast 16. Conveniently, the mast 16 can have two or more sets of holes through which the locking pin 19 can be passed. This enables the mast 16 to be set in two or more positions relative to the base 12. Advantageously, this offers the user of the device 10 options of different maximum heights of the mast 16, and thus also the carriage 20 and supporting head 18, relative to the ground surface on which the wheels 14 of the device 10 rest.

The device 10 also has a carriage lock to releasably retain the carriage 20 at a desired vertical position along the mast 16. As shown in FIG. 3, the carriage lock is, in this particular embodiment, in the form of a retention bolt 21 that is mounted on carriage 20. The retention bolt 21 has a threaded shaft that engages a threaded hole in the carriage 20, and a turn knob that facilitates rotation of the retention bolt 21 by the user. Winding the retention bolt 21 inwards relative to the carriage 20 and the mast 16 causes the threaded shaft to bear against the mast 16. With sufficient pressure, the retention bolt 21 is able to cause the carriage 20 to be retained in position.

Being able to retain the carriage 20 in a desired position along the mast 16 offers two advantages. Firstly, the carriage 20 can be retained in a vertical position, which minimizes the opportunity for the supporting head 18 and sheet material to move unintentionally along the mast 316. Secondly, the cable termination shaft 46 (shown in FIGS. 4 and 5) can be removed from the mast head bracket 40 to release the free end of the cable 34. The cable 34 can then be unwound from the winch 32, and the free end of the cable 34 attached to a lifting point on a truck. With the retention bolt 21 set to retain the carriage 20 in a vertical position on the mast 16, the cable 34 can then be wound back onto the winch 32. As will be appreciated, providing that the lifting point on the truck is above the device 10, this action will cause the device 10 to be lifted up to the lifting point. By reversing this procedure, the device 10 can be lowered from the lifting point. This has the advantage of reducing the manual effort required to move the device 10 on or off a truck.

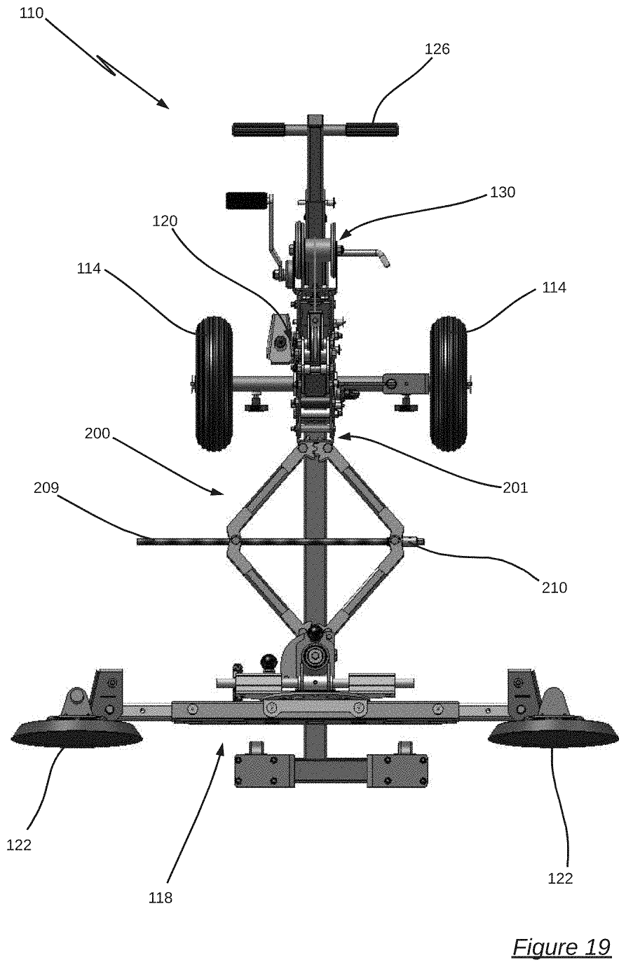

FIGS. 17 to 27 show a device 110 according to a second embodiment of the present invention. The device 110 is intended for use in lifting and transporting sheet material. The device 110 is substantially similar to the device 10 of FIG. 1, and like components of the device 110 have the same reference numeral with the prefix “1”.

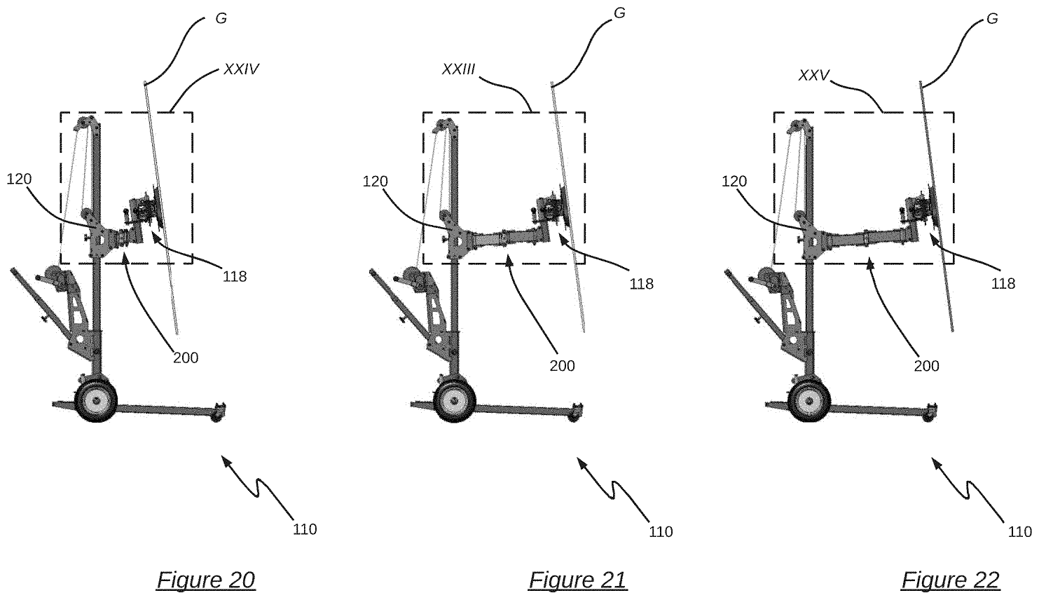

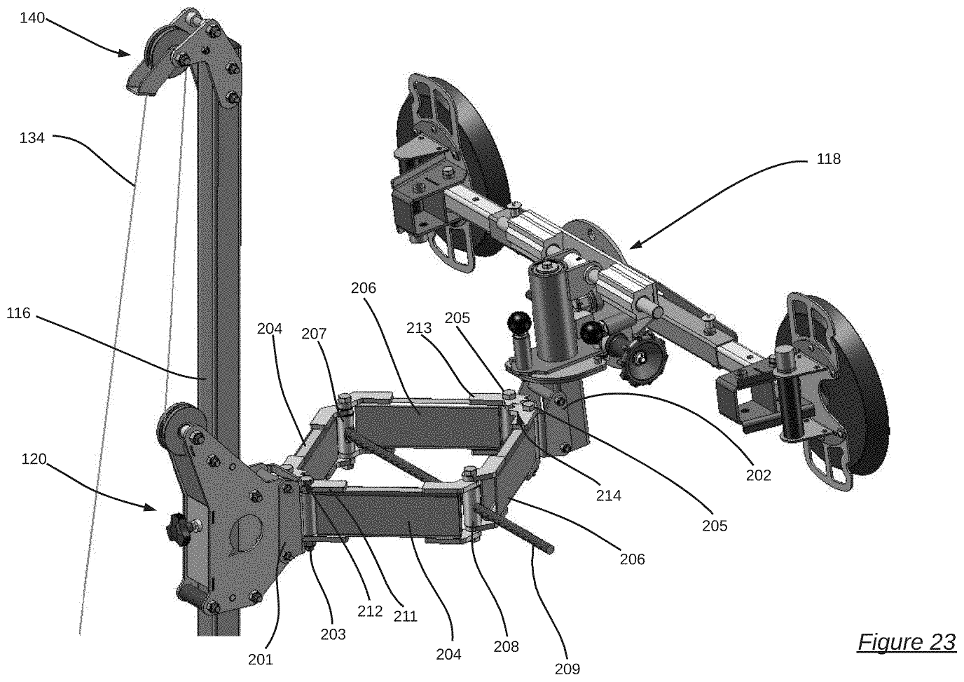

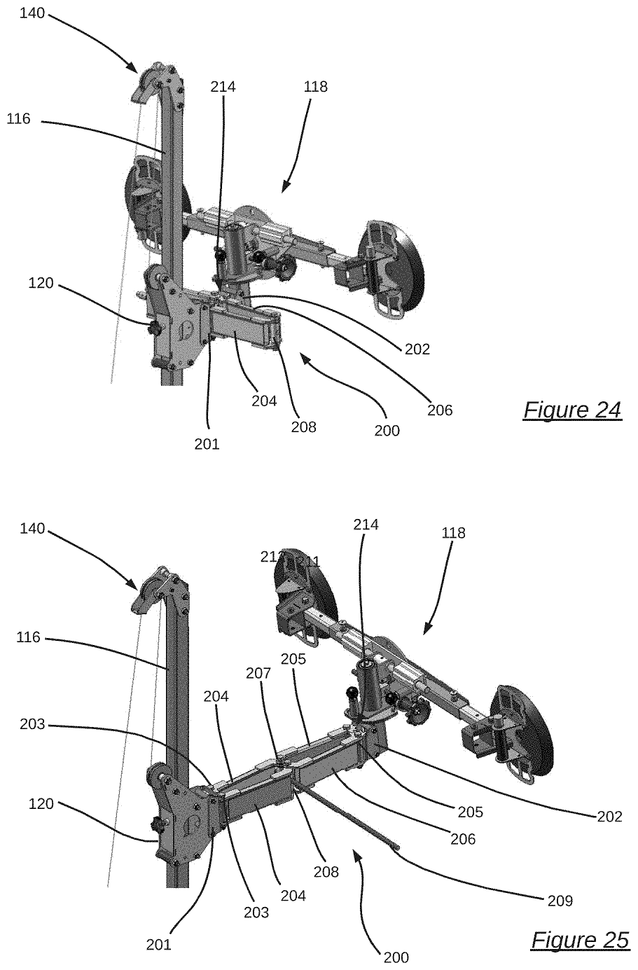

The device 120 includes an extendible arm 200 with an inner end that is connected to the carriage 120, and an outer end that is connected to the supporting head 118. As will be evident from FIGS. 20 to 25, the extendible arm 200 is operable to displace the supporting head 124 in a direction that is generally transverse to the mast 116. The extendible arm 200 can be moved between a retracted position in which the supporting head 118 is proximal to the carriage 120, to an extended position in which the supporting head 118 is spaced from the carriage 120. FIGS. 20 and 24 show the extendible arm 200 in a fully retracted position, and FIGS. 23 and 25 show the extendible arm 200 in a fully extended position. In FIGS. 20 to 22, the device 110 is shown with a glass pane G carried on the supporting head 118.

The extendible arm 200 includes a drive transfer mechanism that has an input connector for connecting to a drive element. The drive transfer mechanism enables an operator of the device 120 to adjust the separation of the carriage 120 and the supporting head 118.

In this embodiment, the extendible arm 200 includes an inner linkage bracket 201 that is connected to the carriage 120, and an outer linkage bracket 202 that is connected to the supporting head 118. The inner linkage bracket 201 has two inner pivots 203, and the extendible arm 200 includes a pair of inner supports 204 are each pivotally connected to a respective one of the inner pivots 203. The outer linkage bracket 202 has two outer pivots 205, and the extendible arm 200 includes a pair of outer supports 206 are each pivotally connected to a respective one of the outer pivots 205. The extendible arm 200 also has two intermediate pivots 207, 208 that each connect one of the inner supports 204 to one of the outer supports 206. The inner and outer supports 204, 206 all have the same length between the respective pivots 203, 205, 207, 208. Further, the two inner pivots 203 are separated by the same distance as the two outer pivots 205. Consequently, the extendible arm 200 forms a parallelogram linkage.

As is evident from the Figures, when the extendible arm 200 is in the fully retracted position, the intermediate pivots 207, 208 are spaced apart, and the inner and outer brackets 201, 202 are adjacent one another. When the extendible arm 200 is in the fully extended position, the intermediate pivots 207, 208 are adjacent one another, and the inner and outer brackets 201, 202 are spaced apart.

In this embodiment, the drive transfer mechanism comprises a leadscrew 209 that has a first end portion (not shown) that is rotationally constrained in a through hole bushing (also not shown) formed in intermediate pivots 207. In other words, the first end portion of the leadscrew 209 can rotate within the through hole bushing of intermediate pivot 207, but the leadscrew 209 cannot be displaced relative to intermediate pivot 207. The leadscrew 209 also has an external threaded portion that is in threaded engagement with an internally threaded through hole (also not shown) that is formed in intermediate pivot 208. Rotation of the leadscrew 209 causes intermediate pivot 208 to displace longitudinally along the leadscrew 209.

The input connector is in the form of a hexagonal drive head 210 that is secured on an first end portion of the leadscrew 209. The drive head 210 can be engaged by a tool, such as a socket on an electric drill or a winder handle. As will be appreciated, rotation of the drive head 210 causes the leadscrew 209 to rotate, and thereby cause displacement of the intermediate pivots 207, 208 relative to one another.

Each of the inner supports 204 includes a pair of inner mesh plates 211, one on each of the top and bottom surfaces of the respective inner support 204. Each inner mesh plate 211 includes a through hole (not shown) through which the respective inner pivot 203 extends, and also a circle segment portion that includes set of gear teeth 212. The gear teeth 212 of each inner mesh plate 211 are in engagement with the gear teeth 212 of a corresponding inner mesh plate 211 on the other inner support 204.

Similarly, each of the outer supports 206 includes a pair of outer mesh plates 213, one on each of the top and bottom surfaces of the respective outer support 206. Each outer mesh plate 213 includes a through hole (not shown) through which the respective outer pivot 215 extends, and also a circle segment portion that includes set of gear teeth 214. The gear teeth 214 of each outer mesh plate 213 are in engagement with the gear teeth 214 of a corresponding outer mesh plate 213 on the other outer support 206.

The sets of gear teeth 212, 214 facilitate synchronizing the pivoting movement of the inner and outer supports 204, 206. In addition, the sets of gear teeth 212, 214 inhibit twisting of the inner and outer linkage brackets 201, 202 relative to one another, which has the advantage of increasing the rigidity of the extendible arm 200.

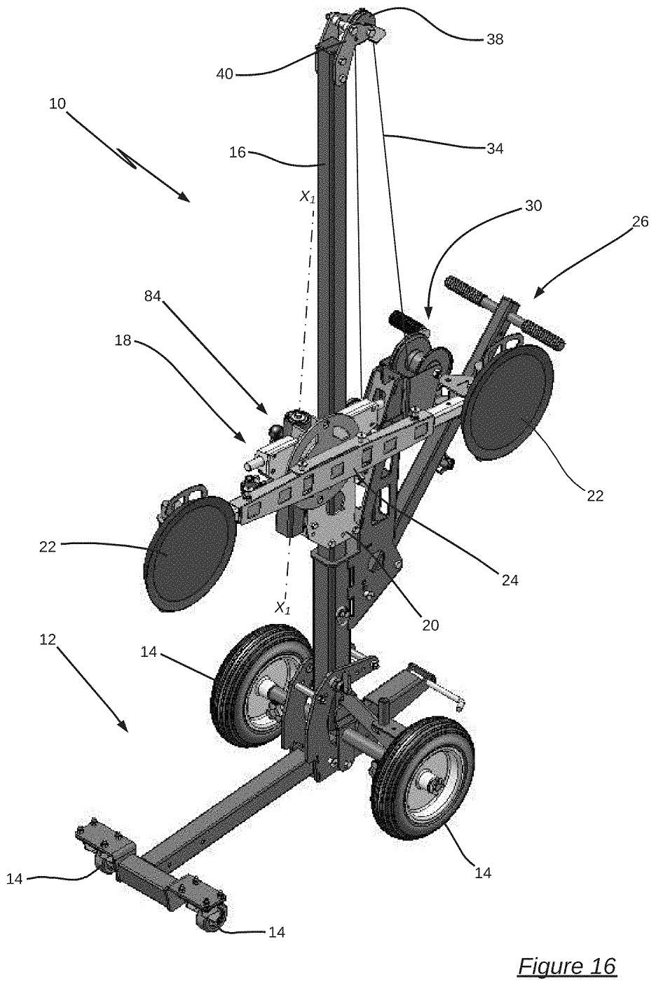

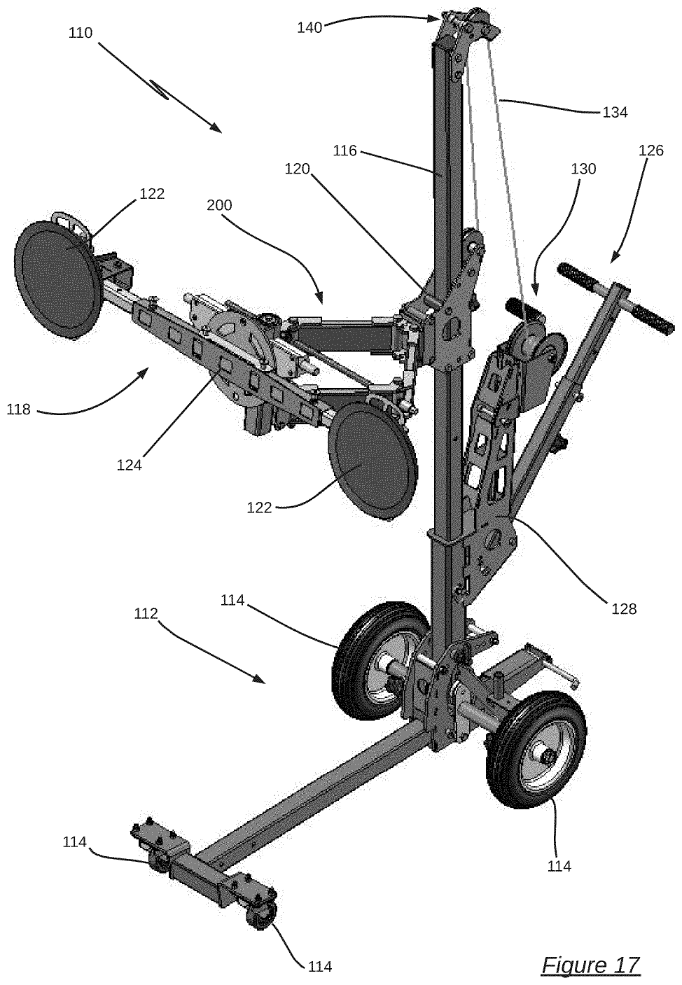

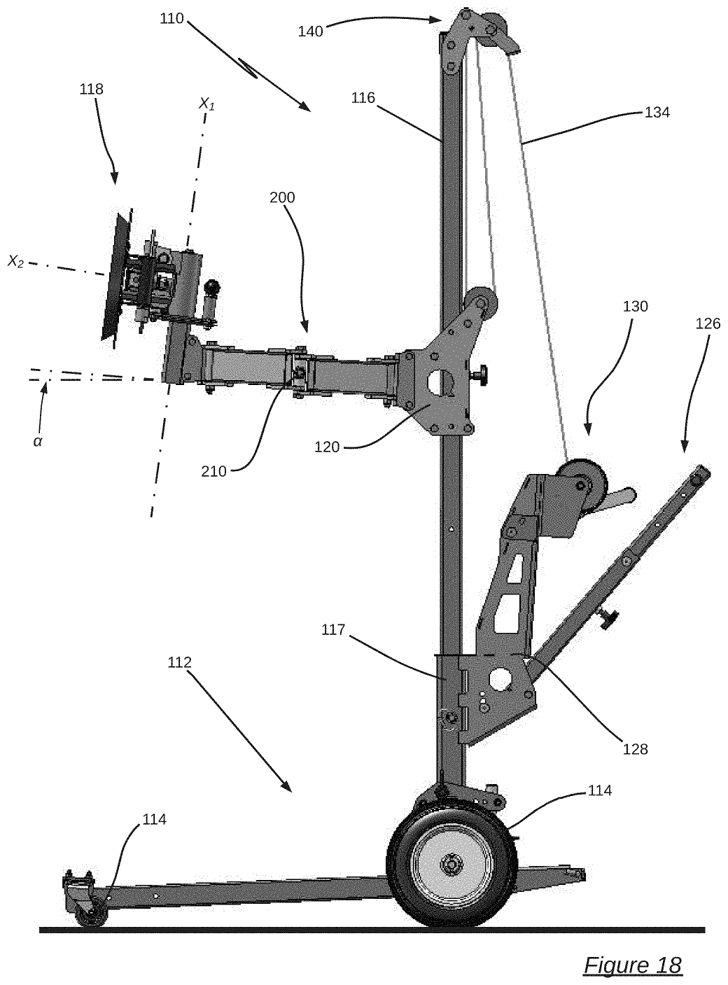

As shown in FIG. 18, the extendible arm 200 is inclined such that the outer linkage bracket 202 is raised relative to the inner linkage bracket 201. This has the benefit in mitigating any sag that may occur when the supporting head 118 is loaded, and the extendible arm 200 is in its fully extended position. In FIG. 18, this inclination is indicated by angle α.

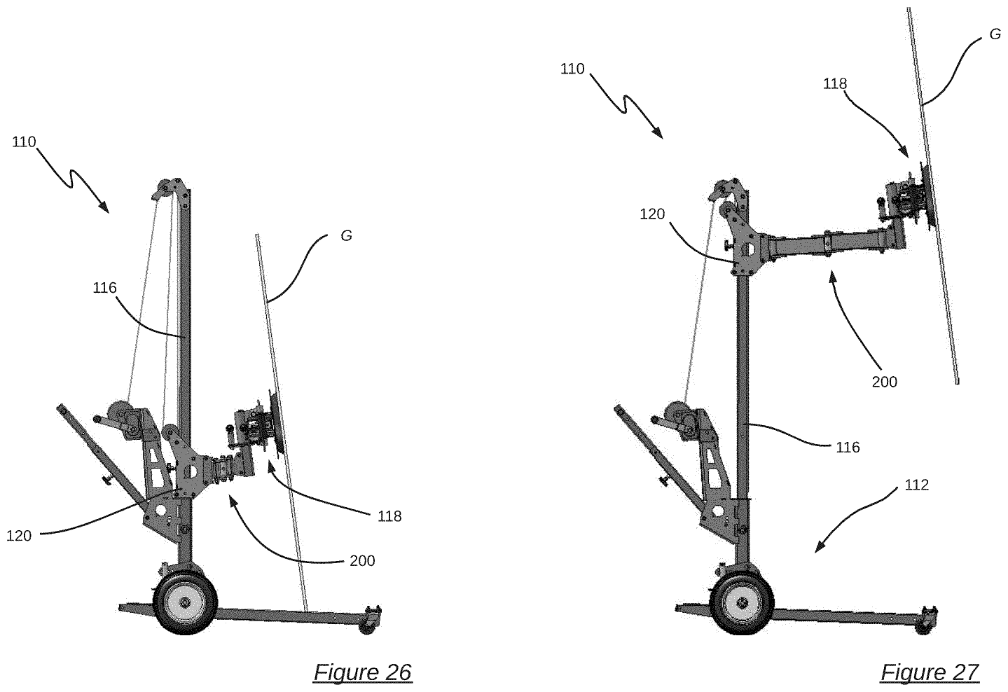

FIGS. 26 and 27 illustrate the range of movement of the supporting head 118 relative to the base 112 that can be achieved by the device 110.

In some embodiments, it may be desirable that the handle of the winch unit 130 may be removable and attached to the drive head 210. It would be understood that a large number of revolutions of the leadscrew 209 would be required to move the extendible arm 200 between the fully extended and fully retracted position. Consequently, at least to minimize the time consumed in this process, it may be preferable to use a power tool, such as a cordless electric drill with an appropriate socket.

In the embodiment illustrated in FIGS. 17 to 27, the extendible arm 200 is arranged such that the axes defined by the inner pivots 203, the outer pivots 205, and the intermediate pivots 207, 208 are transverse to a horizontal plane. Consequently, the inner supports 204 and outer supports 206 lie in a plane that is transverse to the mast 116 in all positions of the extendible head 200 between, and including, the fully retracted and fully extended positions.

In some alternative embodiments, it may be desirable for the extendible arm to be arranged such that the axes defined by the inner pivots, the outer pivots, and the intermediate pivots are approximately parallel to a horizontal plane. In such embodiments, the inner supports and outer supports lie in a plane that is parallel to the mast, in all positions of the extendible head between, and including, the fully retracted and fully extended positions.

FIGS. 28 to 32 show a device 310 according to a third embodiment of the present invention. The device 310 is intended for use in lifting and transporting sheet material.

The device 310 includes a base portion 312, and rear wheels 314a and front wheels 314b on which the base 312 is supported. The wheels 314a, 314b enable the base portion 312, and thus the device 310, to be moved across a surface. The device 310 includes a mast that extends upwardly from the base portion 312.

As shown in FIG. 28, in this particular embodiment the mast includes a lower section 316a, an upper section 316b, and an intermediate section 316c. The intermediate section 316c is removably interconnectable with the lower section 316a, and an upper section 316b is removably interconnectable with both the lower section 316a and the intermediate section 316b. For convenience, the assembled mast sections will hereinafter be referred to as “mast 316”.

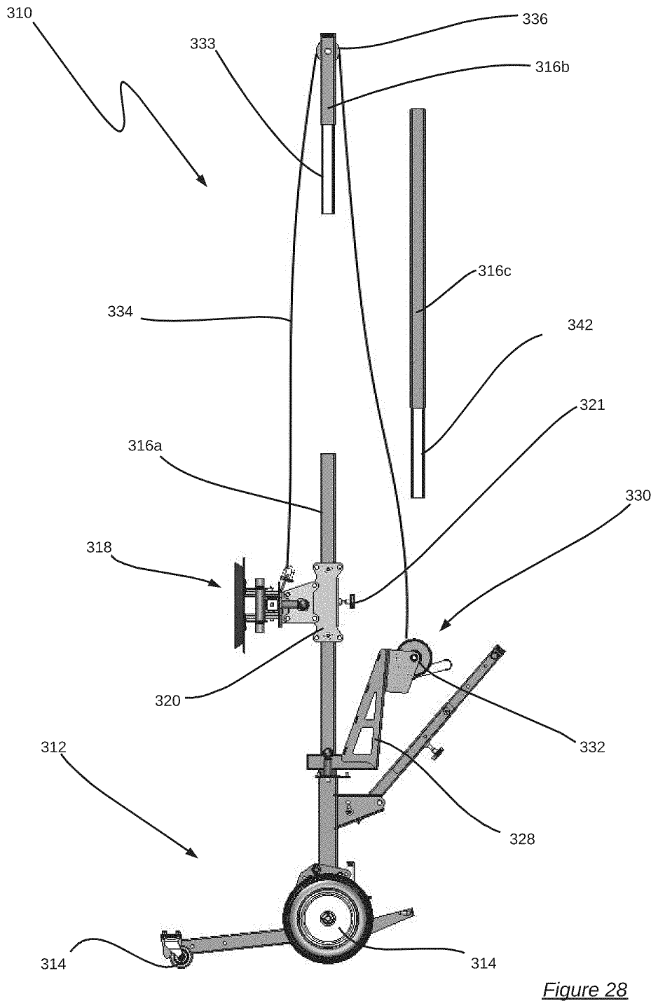

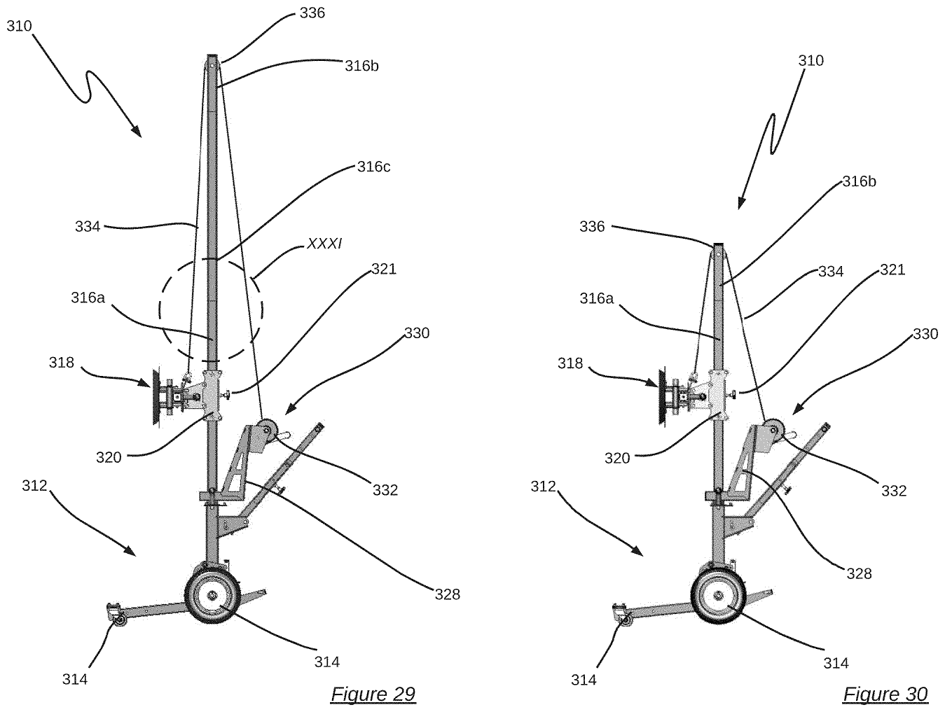

The device 310 can be assembled in a first configuration in which the upper section 316b is connected to the lower section 316a (as shown in FIG. 29). Alternatively, device 310 can be assembled in a second configuration in which the intermediate section 316c is connected to the lower section 316a, and the upper section 316b is connected to the intermediate section 316c (as shown in FIG. 30).

A supporting head 318 is configured to support sheet material is mounted on a carriage 320. The carriage 320 is in engagement with the mast in a manner that enables the carriage 320 to be displaceable along the mast 316, and also be guided by the mast 316. The base, supporting head 318 and carriage 320 of this embodiment are substantially similar to those of the device 10.

It will be evident by comparing FIGS. 29 and 30 that the device 310 is taller in the second configuration than in the first configuration. Further, when assembled in the second configuration, the carriage 320 (and thus also the supporting head 318) can be raised lifted further above the base 312, when compared with the device 310 assembled in the first configuration.

The device 310 has a lifting mechanism to vertically support the carriage 320 along the mast 316. In this particular embodiment, the lifting mechanism including a winch unit 330 with a winch, and a cable 334 that is connected to the winch 332. The cable 334 passes over a pulley 336 located at or near the upper end of the upper mast section 316b, and is secured to the carriage 320.

The device 310 also has a carriage lock to releasably retain the carriage 320 at a desired vertical position along the mast 316. In this embodiment, the carriage lock is in the form of a retention bolt 321 that is mounted on carriage 320. The retention bolt 321 has a threaded shaft that engages a threaded hole in the carriage 320, and a turn knob that facilitates rotation of the retention bolt 321 by the user. Winding the retention bolt 321 inwards relative to the carriage 320 and the mast 316 causes the threaded shaft to bear against the mast 316. With sufficient pressure, the retention bolt 321 is able to cause the carriage 320 to be retained in position.

With the retention bolt 321 set to retain the carriage 320 in a vertical position along the lower section 316a of the mast 316, the cable 334 can be slackened to allow the device 310 to be swapped between the first and second configurations. Consequently, the device 310 can be assembled in the first configuration, which enables the device 310 to be moved into and/or through a space with that has a height restriction, such as a doorway or elevator. Once the device 310 has sufficient clearance from overhead structures, the device 310 can be re-assembled into the second configuration. In this second configuration, the carriage 320 and supporting head 318 can be raised to the full height of the mast 316, together with sheet material that is supported by the supporting head 318. This has the advantage of enabling the device 310 to be used for lifting sheet material to significant heights. For example, in installing a glass pane or IGU above a doorway.

The intermediate section 316c is interconnectable with the lower section 316a by a male-female type connection, and the upper section 316b is removably interconnectable with both the lower section 316a and the intermediate section 316c by a male-female type connection.

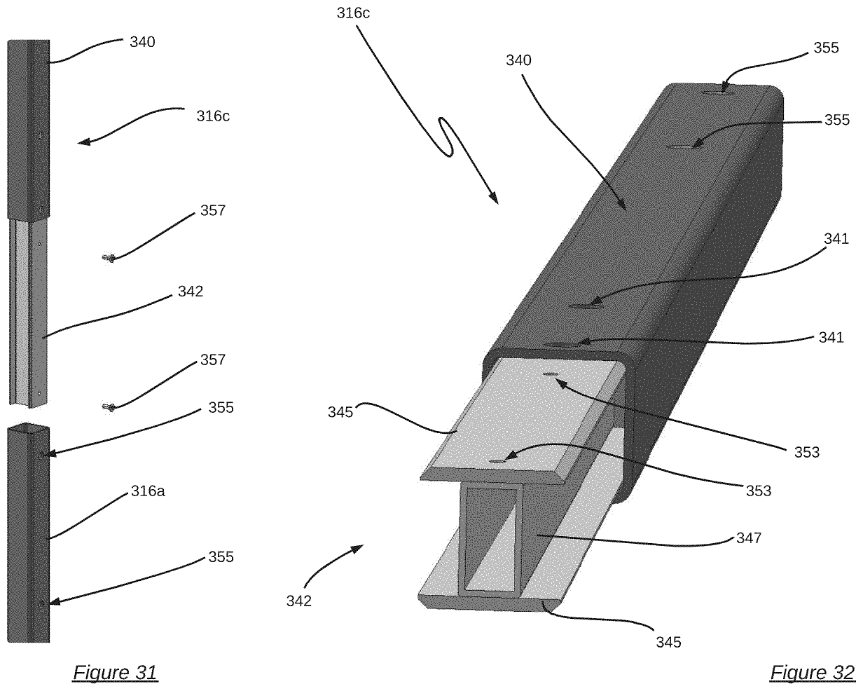

FIG. 32 shows the intermediate section 316c in further detail. The intermediate section 316c has a body portion 340, and a connector portion 342. The body portion 340 is hollow tube. In this embodiment, the hollow tube of the body portion 342 has a substantially square cross section. Thus, the lower section 316a provides the female part of the male-female type connection. The connector portion 342 extends from within the body portion 340 beyond the lower extremity of the body portion 340. Thus, the connector portion 340 provides the male part of the male-female type connection. At least the upper end of the lower section 316a of the mast is hollow, and is configured to receive the exposed part of the connector portion 342.

In this particular embodiment, the connector portion 342 has a pair of flanges 345 that are interconnected by a web formation. In this particular embodiment, the web formation is in the form of a tube member 347. The flanges 345 have bevelled outer edges, which enable the connecting portion 342 to be inserted into the hollow interior of the lower section 316a. When correctly assembled, the lower section 316a, and the body portion 340 of the intermediate section 316c are in abutment, with the four sides of the tubes aligned.

As shown in FIG. 32, the body portion 340 has holes 341. During fabrication of the intermediate section 316c, part of the connector portion 342 is exposed at the holes 341. This enables fillet welds to be made to secure the connector portion 342 within the body portion 340. In this particular embodiment, the body portion 340 has four holes 341 (of which two are visible in FIG. 29), to enable a pair of welds between the body portion 340 and each flange 345.

As shown in FIGS. 31 and 32, one of the flanges 345 has a pair of threaded holes 353. The upper end of the lower section 316a has countersunk apertures 355, which are located on the side of the lower section 316a that is oriented towards the arm 328. When the connector portion 342 of the intermediate section 316c is correctly inserted into lower section 316a, the countersunk apertures align with the threaded holes 353. A pair of head bolts 357 with countersunk heads are then passed through the countersunk apertures 355, and mated with the threaded holes 353. As will be appreciated, this secures the intermediate section 316c relative to the lower section 316a, reducing unwanted movement between these two components.

The connector portion 342 is configured to maintain rigidity of the mast across the join between the lower section 316a, and the intermediate section 316c. In doing so, the interface between the lower section 316a, and the body portion 340 of the intermediate section 316c remain substantially in abutment and in alignment. This enables uninterrupted displacement of the carriage 320 along the mast 316.

As shown in FIG. 28, the lower end of the upper section 316b includes a connector portion 333 that is substantially the same as the connector portion 342 of the intermediate section 316c. The connector portion 342 is configured to be received in either the upper end of the lower section 316a or the upper end of the intermediate section 316c, as required. The connector portion 333 also has threaded holes (not shown in FIG. 28). The upper end of the intermediate section 316c also has countersunk apertures 355, again located on the side of the intermediate section 316c that is to be oriented towards the arm 328 in the assembled device 310. The upper section 316b is to be assembled onto either the lower section 316a or the intermediate section 316c, and secured using bolts with countersunk heads, as described above.

As will be appreciated, securing the upper section 316b to either the lower section 316a or the intermediate section 316c, and the intermediate section 316c to the lower section 316a can also ensure that the mast 316 is assembled in the correct orientation.

In FIG. 29, the connector portion 342 is located internally of the lower section 316a (and also internally of the intermediate section 316c), and thus is not visible in this view. Similarly, in FIGS. 29 and 30, the connector portion 333 is located internally of the intermediate section 316c and the lower section 316a respectively, (and also internally of the upper section 316b), and thus is not visible in these views.

At least the upper portion of the lower section 316a has an outer peripheral surface that guides the carriage 320 during movement along the lower section 316a. The body portions of intermediate section 316c, and the upper section 316b each have an outer peripheral surface that guides the carriage 320 during movement along the mast.

As will be evident from FIGS. 29 and 30, in the assembled device 310, the outer peripheral surfaces in adjacent interconnected sections of the mast are in alignment to guide the carriage 320 across a transition between the outer peripheral surfaces of the adjacent sections of the mast. In addition, in the assembled device, the outer peripheral surfaces in adjacent interconnected sections of the mast are in abutment

In the illustrated embodiment, the base portion 312 also includes an arm 328 that extends rearwardly with respect to the device 310, and the winch unit 330 is connected to the upper end of the arm 328. Further, in this particular embodiment, the winch unit 330 is releasably connected to the arm 328, in the same manner as described above in connection with the embodiment of FIGS. 1 to 15. In some alternative embodiments, the winch unit may be connected, or connectable to another component of the device that is fixed in position relative to the mast. For instance, the mast may be part of a unit that includes the mast, and a side arm to which the winch unit is connected, or is connectable.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A device for lifting and transporting sheet material, the device comprising:
a base portion;
wheels on which the base portion is supported, such that the base portion is movable across a surface on the wheels;
a mast that extends upwardly from the base portion;
a supporting head that is configured to support sheet material above the surface;
a carriage to which the supporting head is mounted, the carriage is in engagement with the mast so that carriage is slidable along the mast and is guided by the mast; and
a lifting mechanism to support the carriage in the longitudinal direction of the mast, the lifting mechanism including a winch, and a cable that is connected to the winch, passes over a first pulley located at or near the upper end of the mast and under a second pulley that is mounted on the carriage, and an end of the cable is secured or securable at or adjacent an upper end of the mast, wherein the winch and the first and second pulleys are all positioned on one side of the mast, and wherein the carriage is displaceable along the mast by operation of the winch.

2. A device according to claim 1, further comprising a handle that extends from the base portion in a rearward direction of the device, and wherein the winch and the first and second pulleys are positioned between the mast and the handle.

3-4. (canceled)

5. A device according to claim 1, further comprising a cable guide for guiding a portion of the cable that is between the first pulley and the winch onto the first pulley.

6. A device according to claim 1, further comprising a mast head bracket at the upper end of the mast, wherein the first pulley is supported on the mast head bracket, and wherein the mast head bracket includes a shaft member on which the first pulley is rotatably mounted, and wherein the cable guide is mounted on the shaft member, whereby the transverse portion of the cable guide is rotatable about the shaft member.

7. A device according to claim 1, further comprising a mast head bracket at the upper end of the mast, wherein the first pulley is supported on the mast head bracket, and wherein the mast head bracket includes a guide pin located between the first pulley and the mast, and wherein the guide pin inhibits the cable moving out of a circumferential groove of the first pulley.

8. A device according to claim 1, further comprising a winch mounting member to which the winch is mounted, or is mountable, and wherein, when the winch is mounted to the device, the winch is in a fixed position relative to the mast.

9. (canceled)

10. A device for lifting and transporting sheet material, the device comprising:
a base portion;
wheels on which the base portion is supported, such that the base portion is movable across a surface on the wheels;
a mast that extends upwardly from the base portion;
a supporting head that is configured to support sheet material above the surface;
a carriage to which the supporting head is mounted, the carriage being in engagement with the mast so that carriage is slidable along the mast and being guided by the mast; and
a lifting mechanism to support the carriage in the longitudinal direction of the mast, the lifting mechanism having:
a winch unit that includes a winch and a mounting bracket on which the winch is mounted, the mounting bracket being releasably connectable by a coupling to one of the base portion, or a component of the device that is fixed relative to the mast,
a cable that is connected to the winch, and
one or more pulleys, at least one of which is located at or near the upper end of the mast,
wherein an end of the cable is secured or securable at one of the carriage, or a position on or adjacent an upper end of the mast, such that the carriage is displaceable along the mast by operation of the winch.

11. A device according to claim 10, wherein the coupling of the lifting mechanism includes one or more connecting members that secure the winch unit to the base.

12. A device according to claim 10, wherein the coupling of the lifting mechanism includes one or more complementary inter-engaging formations that, when inter-engaged, inhibit separation of the base portion and the winch unit.

13. (canceled)

14. A device according to claim 10, wherein the base portion and mounting bracket are configured to overlap when the winch unit is connected to the base portion, and each of the base portion and mounting bracket have holes that are positioned so as to align when the winch unit is connected to the base portion, and the connecting members include a pin-type connecting member with a shank that passes through aligned holes in the base portion and mounting bracket to secure the winch unit to the base portion.

15. (canceled)

16. A device according to claim 10, wherein:
the connecting members include a key member that projects from the base portion,
the mounting bracket has a slot, and
the key member and slot are shaped such that, when the winch unit is connected to the base portion, the key member inter-engages with the mounting bracket around the slot to inhibit separation of the base portion and the winch unit.

17. (canceled)

18. A device according to claim 10, wherein the base portion includes a winch mounting member to which the mounting bracket of the winch unit is releasably connectable.

19. A device according to claim 1, further comprising an extendible arm having:
an inner end that is connected to the carriage;
an outer end that is connected to the supporting head; and
a drive transfer mechanism that has an input connector for connecting to a drive element,
wherein the drive transfer mechanism is operable via the input connector to adjust the separation of the carriage and the supporting head such that the extendible arm is operable to displace the supporting head in a direction transverse to the mast from a retracted position in which the supporting head is proximal to the carriage, to an extended position in which the supporting head is spaced from the carriage.

20. A device according to claim 19, wherein the extendible arm includes a parallelogram linkage comprising:
an inner linkage bracket that is connected to the carriage;
an outer linkage bracket that is connected to the supporting head;
a pair of inner supports that are each pivotally connected to the inner linkage bracket;
a pair of outer supports that are each pivotally connected to the outer linkage bracket;
two intermediate pivots that each connect one of the inner supports to one of the outer supports,
wherein when the extendible arm is in the retracted position, the intermediate pivots are spaced apart and the inner and outer brackets are adjacent one another,
wherein when the extendible arm is in the extended position, the intermediate pivots are adjacent one another and the inner and outer brackets are spaced apart.

21. A device according to claim 20, wherein a first of the intermediate pivots has a through hole bushing, and a second of the intermediate pivots has an internally threaded through hole, and the drive transfer mechanism comprises a leadscrew that has a first end portion that is rotationally constrained in the through hole bushing of the first intermediate pivot, and an external threaded portion that is in threaded engagement with the internally threaded through hole of the second intermediate pivot,
and wherein the input connector is in the form of a drive head on an end of the leadscrew, the drive head being shaped to be engaged by a tool, such that rotation of the drive head causes the leadscrew to rotate and thereby cause displacement of the intermediate pivots relative to one another.

22. A device according to claim 19, wherein the outer linkage bracket has two outer pivots, and each outer support is pivotally connected to a respective one of the outer pivots,
wherein each of the outer supports includes one or more outer mesh plates, each outer mesh plate includes a through hole through which the respective outer pivot extends, and a circle segment portion that includes set of gear teeth,
and wherein the gear teeth of each outer mesh plate are in engagement with the gear teeth of a corresponding outer mesh plate on the other outer support.

23. A device according to claim 20, wherein the inner linkage bracket has two inner pivots, and each inner support is pivotally connected to a respective one of the inner pivots,
wherein each of the inner supports includes one or more inner mesh plates, each inner mesh plate includes a through hole through which the respective inner pivot extends, and a circle segment portion that includes set of gear teeth,
and wherein the gear teeth of each inner mesh plate are in engagement with the gear teeth of a corresponding inner mesh plate on the other inner support.

24. A device for lifting and transporting sheet material, the device comprising:
a base portion;
wheels on which the base portion is supported, such that the base portion is movable across a surface on the wheels;
a mast that extends upwardly from the base portion, the mast including a lower section that is connected to the base portion, at least one intermediate section that is configured to be removably interconnectable with the lower section, and an upper section that is removably interconnectable with both the lower section and the intermediate section;
a supporting head that is configured to support sheet material above the surface;
a carriage to which the supporting head is mounted, the carriage being in engagement with the mast so that carriage is displaceable along the mast and being guided by the mast; and
a lifting mechanism to support the carriage in the longitudinal direction of the mast, the lifting mechanism having:
a winch unit that includes a winch and a mounting bracket on which the winch is mounted, the mounting bracket being releasably connectable by a coupling to one of the base portion, or a component of the device that is fixed relative to the mast,
a cable that is connected to the winch, and
one or more pulleys, at least one of which is located at or near the upper end of the upper section of the mast,
wherein an end of the cable is secured or securable at one of the carriage, or a position on or adjacent an upper end of the upper section, such that the carriage is displaceable along the mast by operation of the winch.

25. A device according to claim 24, wherein the intermediate section is interconnectable with the lower section by a male-female type connection, and the upper section is removably interconnectable with both the lower section and the intermediate section by a male-female type connection, and wherein the upper end of the lower section is hollow to provide the female part of the male-female type connection, the intermediate section and upper section each have a connector portion that provides the male part of the male-female type connection, and the upper end of the intermediate section is hollow to provide the female part of the male-female type connection.

26. (canceled)

27. A device according to claim 24, wherein at least an upper portion of the lower section has an outer peripheral surface that guides the carriage during movement along the lower section, and the intermediate section and the upper section each have a body portion with an outer peripheral surface that guides the carriage during movement along the mast,
and wherein in the assembled device, the outer peripheral surfaces in adjacent interconnected sections of the mast are in alignment to guide the carriage across a transition between the outer peripheral surfaces of the adjacent sections of the mast.

28. (canceled)
